(19) United States
(12) Patent Application Publication
(10) Pub. No.: US 2026/0017926 A1
(43) Pub. Date: Jan. 15, 2026

(54) SYSTEM AND METHOD OF PIXEL GROUNDING LARGE MULTIMODAL MODEL

(71) Applicant: Mohamed bin Zayed University of Artificial Intelligence, Abu Dhabi (AE)

(72) Inventors: Hanoona BANGALATH, Abu Dhabi (AE); Muhammad MAAZ, Abu Dhabi (AE); Sahal Shaji MULLAPPILLY, Abu Dhabi (AE); Abdelrahman YOUSSIEF, Abu Dhabi (AE); Salman KHAN, Abu Dhabi (AE); Hisham CHOLAKKAL, Abu Dhabi (AE); Rao ANSWER, Abu Dhabi (AE); Eric XING, Abu Dhabi (AE); Fahad S. KHAN, Abu Dhabi (AE)

(73) Assignee: Mohamed bin Zayed University of Artificial Intelligence, Abu Dhabi (AE)

(21) Appl. No.: 18/773,346

(22) Filed: Jul. 15, 2024

(51) Int. Cl. G06V 10/771; G06T 7/12; G06T 9/00; G06V 10/25; G06V 10/44; G06V 20/70

(52) U.S. Cl. CPC G06V 10/771; G06T 7/12; G06T 9/00; G06V 10/25; G06V 10/44; G06V 20/70; G06T 2207/20016; G06V 2201/07

(57) ABSTRACT

A system and method for grounded multimodal conversation in which a global image encoder is connected to a vision-to-language (V-L) projection layer for encoding an image and projecting the image into scene text. A region encoder constructs a feature pyramid from layers of the global image encoder, followed by a Region of Interest layer to generate a feature map. The V-L projection layer maps features into projected image features. A large language model receives an input of an augmentation of text instruction and features and generates a conversation concerning the image. A language-to-prompt projection layer transforms last-layer embeddings of the large language model corresponding to segment tokens into a pixel space then a pixel decoder utilizes the pixel feature space together with a grounding image encoder to produce pixel-level object grounding.

### STATEMENT REGARDING PRIOR DISCLOSURE BY THE INVENTORS

Aspects of this technology are described in an article “Rasheed, Hanoona, Muhammad Maaz, Sahal Shaji, Abdelrahman Shaker, Salman Khan, Hisham Cholakkal, Rao M. Anwer, Erix Xing, Ming-Hsuan Yang, and Fahad S. Khan. “Glamm: Pixel grounding large multimodal model.” arXiv preprint arXiv:2311.03356 (2023), and is herein incorporated by reference in its entirety.

### BACKGROUND

### Technical Field

The present disclosure is directed to a machine learning model, method and system that generates natural language responses intertwined with corresponding object segmentation masks. The model, method and system grounds objects appearing in natural language conversations and accepts both textual and/or optional visual prompts as inputs.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A Large Multimodal Model (LMM) is a type of advanced artificial intelligence system that has the capability to process and understand information from multiple data types or modalities simultaneously. The LMM can interact with multiple forms of data, including text, images, audio, and video. This multimodal approach mirrors human cognitive processes more closely, allowing for more intuitive and efficient interactions between humans and AI systems. The advancements in LMMs enable AI that can understand and operate in the multifaceted world.

Conventional LMMs provide a versatile interface for a diverse array of tasks, encompassing language and vision. Prominent models such as BLIP-2, LLaVA, InstructBLIP and MiniGPT-4 first conduct image-text feature alignment followed by instruction tuning. See Junnan Li, Dongxu Li, Silvio Savarese, and Steven Hoi. BLIP-2: bootstrapping language-image pre-training with frozen image encoders and large language models. In ICML, 2023; Haotian Liu et al., Visual instruction tuning; Dai et al.; and Zhu et al Other representative works include Otter, mPLUG-Owl, LLaMa-Adapter, Video-ChatGPT, InternGPT. However, these approaches lack region-specific understanding. See Renrui Zhang, Jiaming Han, Aojun Zhou, Xiangfei Hu, Shilin Yan, Pan Lu, Hongsheng Li, Peng Gao, and Yu Qiao. Llama-adapter: Efficient fine-tuning of language models with zero-init attention. arXiv:2303.16199, 2023; Muhammad Maaz, Hanoona Rasheed, Salman Khan, and Fahad Shahbaz Khan. Video-chatgpt: Towards detailed video understanding via large vision and language models. arXiv:2306.05424, 2023.

Hence, Large Multimodal Models (LMMs) have emerged as a pivotal advancement, bridging the gap between vision and language tasks. See Muhammad Awais, Muzammal Naseer, Salman Khan, Rao Muhammad Anwer, Hisham Cholakkal, Mubarak Shah, Ming-Hsuan Yang, and Fahad Shahbaz Khan. Foundational models defining a new era in vision: A survey and outlook. arXiv:2307.13721, 2023. Initial efforts demonstrated effective textual responses based on input images. See Wenliang Dai, Junnan Li, Dongxu Li, Anthony Meng Huat Tiong, Junqi Zhao, Weisheng Wang, Boyang Li, Pascale Fung, and Steven Hoi. Instructblip: Towards general-purpose vision-language models with instruction tuning. arXiv:2305.06500, 2023; Peng Gao, Jiaming Han, Renrui Zhang, Ziyi Lin, Shijie Geng, Aojun Zhou, Wei Zhang, Pan Lu, Conghui He, Xiangyu Yue, Hongsheng Li, and Yu Qiao. Llama-adapter v2: Parameter-efficient visual instruction model. arXiv:2304.15010, 2023; Bo Li, Yuanhan Zhang, Liangyu Chen, Jinghao Wang, Jingkang Yang, and Ziwei Liu. Otter: A multi-modal model with in-context instruction tuning. arXiv:2305.03726, 2023; Haotian Liu, Chunyuan Li, QingyangWu, and Yong Jae Lee. Visual instruction tuning. In NeurIPS, 2023; Qinghao Ye, Haiyang Xu, Guohai Xu, Jiabo Ye, Ming Yan, Yiyang Zhou, Junyang Wang, Anwen Hu, Pengcheng Shi, Yaya Shi, Chenliang Li, Yuanhong Xu, Hehong Chen, Junfeng Tian, Qian Qi, Ji Zhang, and Fei Huang. mplug-owl: Modularization empowers large language models with multimodality. arXiv:2305.03726, 2023; and Deyao Zhu, Jun Chen, Xiaoqian Shen, Xiang Li, and Mohamed Elhoseiny. Minigpt-4: Enhancing vision-language understanding with advanced large language models. arXiv:2304.10592, 2023. Although these models are sophisticated, they cannot ground their responses in a visual context. Such grounding is important for advanced applications like detailed visual understanding, interactive embodied agents, and localized content manipulation.

Conventional efforts address this limitation by enabling models to process user-defined regions specified via bounding boxes. See Keqin Chen, Zhao Zhang, Weili Zeng, Richong Zhang, Feng Zhu, and Rui Zhao. Shikra: Unleashing multimodal llm's referential dialogue magic. arXiv:2306.15195, 2023; Keqin Chen, Zhao Zhang, Weili Zeng, Richong Zhang, Feng Zhu, and Rui Zhao. Shikra: Unleashing multimodal llm's referential dialogue magic. arXiv:2306.15195, 2023; Zhiliang Peng, Wenhui Wang, Li Dong, Yaru Hao, Shaohan Huang, Shuming Ma, and Furu Wei. Kosmos-2: Grounding multimodal large language models to the world. arXiv:2306.14824, 2023; Renjie Pi, Jiahui Gao, Shizhe Diao, Rui Pan, Hanze Dong, Jipeng Zhang, Lewei Yao, Jianhua Han, Hang Xu, Lingpeng Kong, and Tong Zhang. Detgpt: Detect what you need via reasoning. arXiv:2305.14167, 2023; and Shilong Zhang, Peize Sun, Shoufa Chen, Min Xiao, Wenqi Shao, Wenwei Zhang, Kai Chen, and Ping Luo. Gpt4roi: Instruction tuning large language model on region-of-interest. arXiv:2307.03601, 2023.

Kosmos-2, Shikra, GPT4RoI, VisionLLM, Ferret and All-Seeing aim to allow region-specific conversation. See Shilong Zhang et al.; Wenhai Wang, Zhe Chen, Xiaokang Chen, Jiannan Wu, Xizhou Zhu, Gang Zeng, Ping Luo, Tong Lu, Jie Zhou, Yu Qiao, et al. Visionllm: Large language model is also an open-ended decoder for vision-centric tasks. arXiv:2305.11175, 2023; Ye et al.; and Weiyun Wang, Min Shi, Qingyun Li, Wenhai Wang, Zhenhang Huang, Linjie Xing, Zhe Chen, Hao Li, Xizhou Zhu, Zhiguo Cao, et al. The all-seeing project: Towards panoptic visual recognition and understanding of the open world. arXiv:2308.01907, 2023. Some methods input location bins and bounding boxes with image data for region-level understanding, relying on the LLM exclusively for interpreting these regions. See Haoxuan You, Haotian Zhang, Zhe Gan, Xianzhi Du, Bowen Zhang, Zirui Wang, Liangliang Cao, Shih-Fu Chang, and Yinfei Yang. Ferret: Refer and ground anything anywhere at any granularity. arXiv:2310.07704, 2023. GPT4RoI advances this by using spatial boxes and RoI-aligned features for input and training on region-text pairs. BuboGPT utilizes an off-the-shelf grounding model and matches the groundings with the language response. See Shilong Liu, Zhaoyang Zeng, Tianhe Ren, Feng Li, Hao Zhang, Jie Yang, Chunyuan Li, Jianwei Yang, Hang Su, Jun Zhu, et al. Grounding dino: Marrying dino with grounded pre-training for open-set object detection. arXiv:2303.05499, 2023. In contrast, LISA utilizes embeddings from the vision language model and the SAM decoder to generate output segmentation masks. However, LISA cannot comprehend specific image regions or handle multiple instances.

Subsequently, the LMM methods can be partitioned into four distinct categories (see Table. 1—separated via dotted lines). The first category encompasses models effective in textual responses but lacking in region-specific capabilities. See Visual instruction tuning; Zhengyuan Yang, Linjie Li, Jianfeng Wang, Kevin Lin, Ehsan Azarnasab, Faisal Ahmed, Zicheng Liu, Ce Liu, Michael Zeng, and Lijuan Wang. Mm-react: Prompting chatgpt for multimodal reasoning and action. arXiv:2303.11381, 2023. In contrast, among models that handle region inputs or offer visual grounding, three more categories emerge. The first of these categories incorporates external vision modules, and the next category relies exclusively on LMMs for region understanding. Large language model is also an open-ended decoder for vision-centric tasks. The last category combines specialized vision modules with LMMs, trained end-to-end for a comprehensive understanding of regions.

However, despite a capability of grounded text response generation, conventional LMMs have not achieved detailed pixel-level groundings. See Xin Lai, Zhuotao Tian, Yukang Chen, Yanwei Li, Yuhui Yuan, Shu Liu, and Jiaya Jia. Lisa: Reasoning segmentation via large language model. arXiv:2308.00692, 2023; and Yang Zhao, Zhijie Lin, Daquan Zhou, Zilong Huang, Jiashi Feng, and Bingyi Kang. Bubogpt: Enabling visual grounding in multi-modal llms. arXiv:2307.08581, 2023. Parallel to these, efforts have been made in the referring segmentation literature to ground textual descriptions in natural images. These conventional LMMs are limited to grounding a single object and cannot engage in natural, coherent conversations, thereby restricting their practical applicability in interactive tasks that demand a deep understanding of both visual and textual content.

Accordingly, it is one object of the present disclosure to provide methods and systems for generating natural language responses seamlessly integrated with object segmentation masks. A further object includes methods and systems that accommodate textual and visual prompts, facilitating enhanced multimodal user interaction.

A further object is methods and systems for a Grounded Conversation Generation (GCG) task and a comprehensive evaluation protocol to measure the efficacy of models for GCG that unifies multiple isolated tasks, filling a significant gap in the literature.

To facilitate model training and evaluation, an object is a Grounding-anything Dataset (GranD), a large-scale densely annotated dataset. Additionally, an object is GranD_{f}, a high-quality dataset explicitly designed for the GCG task finetuning, that repurposes existing open-source datasets.

### SUMMARY

An aspect of the present disclosure is a system for grounded multimodal conversation, that can include an input for receiving an image; a global image encoder connected to a vision-to-language (V-L) projection layer for encoding the image and projecting the encoded image into scene text; a region encoder configured to construct a hierarchical feature pyramid from selected layers of the global image encoder, followed by a Region of Interest align layer to generate a region of interest feature map, wherein the V-L projection layer configured to map features of the region of interest feature map into projected image features in language domain; a large language model configured to receive an input of an augmentation of text instruction and region features and generate a grounded conversation concerning the image; a language-to-prompt projection layer configured to transform last-layer embeddings of the large language model corresponding to segment tokens into a pixel decoder feature space; a grounding image encoder, and wherein the pixel decoder utilizes the pixel decoder feature space together with the grounding image encoder to produce fine-grained pixel-level object grounding.

In a further aspect of the present disclosure, a non-transitory computer-readable storage medium including computer executable instructions, wherein the instructions, when executed by a computer, cause the computer to perform a method for grounded multimodal conversation, the method can include receiving an image; encoding, by a global image encoder connected to a vision-to-language (V-L) projection layer, the image and projecting the encoded image into scene text; constructing, by a region encoder, a hierarchical feature pyramid from selected layers of the global image encoder, followed by generating, by a Region of Interest align layer, a region of interest feature map; mapping, by the V-L projection layer, features of the region of interest feature map into projected image features in language domain; receiving, by a large language model, an input of an augmentation of text instruction and region features and generating a grounded conversation concerning the image;

transforming, by a language-to-prompt projection layer, last-layer embeddings of the large language model corresponding to segment tokens into a pixel decoder feature space; and producing, by the pixel decoder utilizing the pixel decoder feature space together with the grounding image encoder, fine-grained pixel-level object grounding.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIGS. 1A, 1B illustrates a user interaction for Grounded Conversation Generation with GLaMM, in accordance with an exemplary aspect of the disclosure;

FIGS. 2A, 2B, illustrates the architecture of GLaMM, FIGS. 2C, 2D, 2E, 2F illustrate downstream applications of GLaMM, including FIG. 2C referring expression segmentation, FIG. 2D image-level captioning, FIG. 2E region-level captioning, and FIG. 2F phrase grounding;

FIGS. 3A, 3B, 3C are user interfaces illustrating qualitative results of GLaMM on grounded conversation generation;

FIGS. 4A-4E illustrates an automatic annotation pipeline of a dataset, including FIG. 4B Level 1, FIG. 4C Level 2, FIG. 4D Level 3, FIG. 4E Level 4;

FIGS. 5A, 5B, 5C are user interfaces illustrating qualitative results of GLaMM's performance across downstream tasks, including FIG. 5A region level understanding, FIG. 5B referring-expression segmentation, and FIG. 5C image-level captioning;

FIG. 6 is a user interface illustrating an example to generate a segmentation mask for a specific phrase;

FIGS. 7A, 7B, 7C are user interfaces illustrating qualitative results of GLaMM's performance in grounded conversation generation;

FIGS. 8A, 8B, 8C are user interfaces illustrating a qualitative results in GLaMM's capability in referring expression segmentation;

FIGS. 9A, 9B, 9C are user interfaces illustrating qualitative GLaMM's performance in region-level captioning;

FIGS. 10A, 10B, 10C, 10D are user interfaces illustrating qualitative results of GLaMM on image-level captioning tasks;

FIGS. 11A, 11B are user interfaces illustrating multimodal conversational interactions facilitated by GLaMM;

FIGS. 12A, 12B, 12C, 12D are user interfaces illustrating qualitative results of GLaMM on conditional image generation;

FIGS. 13A-13H are user interfaces illustrating multimodal conversations with GLaMM;

FIGS. 14A-14I are user interfaces illustrating dataset samples from GranD_{f}.

FIGS. 15A, 15B are user interfaces illustrating dataset samples from GranD; and

FIG. 16 is a block diagram illustrating an exemplary computer system for machine learning.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for a task of Grounded Conversation Generation (GCG). The GCG task requires densely grounded concepts in natural scenes at a large-scale. An aspect is an automated pipeline that annotates the large-scale Grounding-anything Dataset (GranD). An aspect is downstream tasks including region and image captioning, referring segmentation, and vision-language conversations.

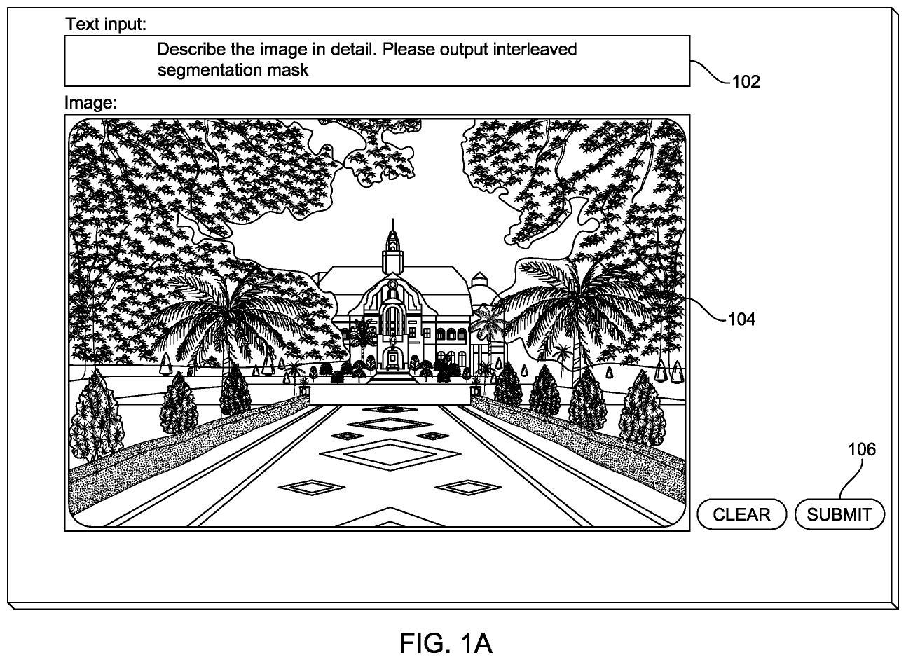

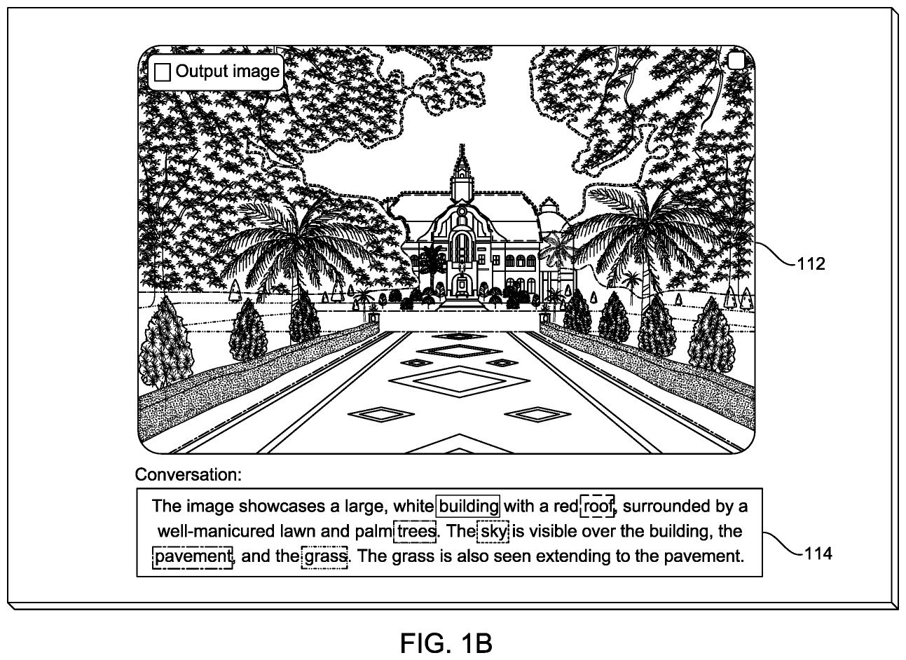

FIGS. 1A, 1B illustrates an exemplary Grounded Conversation Generation with Grounding LMM (GLaMM). The multimodal conversational model can provide natural language responses grounded at the pixel-level in the input image. In image segmentation, every pixel in an image is assigned a label such that pixels with the same label share some visual characteristics. The natural language responses can take on different levels of granularity depicted in the output groundings, e.g., things (building, tree), stuff (grass, sky, pavement), and object parts (roof as a subpart of the building) alongside the object attributes (white house, red roof, well-manicured lawn) and object relationships (grass extending to the pavement, sky over the building). In contrast, conventional LMMs, open-source (e.g., LLaVa, miniGPT4, Shikra, Kosmos-2) and closed-source (e.g., GPT4-V, Bard), do not have a capability of pixel-level grounded conversational.

As an exemplary use of the system, as in FIG. 1A, a user interface may be provided that contains a field for entering text 102. The user interface may include a field for inputting or selecting an image 104. The image may be input by dragging and dropping an image into the user interface. Alternatively, an image may be selected by browsing local memory or some other storage medium where images may be stored. The text that is entered in a text box 102 can be a request for action on the input image 104. Actions can include a request for identification of an object(s) in the image and/or showing regions or object segmentation. Once text and an image are input in the user interface, the input may be submitted, for example, by way of a submit button 106. The user interface may have an optional Clear button to clear the input fields.

The system, as in FIG. 1B, can output an image(s) and/or text in response to the input. In an example output, the system displays a segmented image 112 and a text response 114.

Still, the diverse capabilities of the GLaMM system, especially a pixel-level grounded conversational capability, do not presently have benchmarks. To address the lack of benchmarks for visually grounded conversations, an aspect is a task of Grounded Conversation Generation (GCG). The GCG task aims to produce natural language responses interleaved with object segmentation masks. This task unifies several existing tasks in computer vision that are typically treated in isolation, i.e., referring expression segmentation, image and region-level captioning, phrase grounding, and vision-language conversations. Thereby, a unified model and proposed pretraining dataset can effectively transfer to several downstream tasks (referring expression segmentation, region-level captioning, image captioning, and conversational-style QA). Unlike conventional works, GLaMM can work with both textual and visual prompts and can generate visually grounded outputs, thus offering a versatile user experience.

Detailed region-level understanding typically requires the laborious process of collecting large-scale annotations for image regions. An aspect is an automated pipeline that annotates the large-scale Grounding-anything Dataset (GranD) to alleviate the manual labeling effort. Leveraging the automated pipeline with dedicated verification steps, GranD has been generated with 7.5M unique concepts anchored in 810M regions, each with a segmentation mask. Using state-of-the-art vision and language models, the dataset pipeline annotates SAM images through a multi-level hierarchical scheme that enhances annotation quality. For further information on SAM, see Alexander Kirillov, Eric Mintun, Nikhila Ravi, Hanzi Mao, Chloe Rolland, Laura Gustafson, Tete Xiao, Spencer Whitehead, Alexander C. Berg, Wan-Yen Lo, Piotr Dollár, and Ross Girshick. Segment anything. arXiv:2304.02643, 2023, incorporated herein by reference in its entirety. With 11M images, 84M referring expressions, and 33M grounded captions, GranD sets a new benchmark in comprehensiveness. In addition to the automatically generated dataset for the GCG, a high-quality dataset is disclosed for grounded conversations obtained by revamping the existing manually annotated datasets for GCG using GPT-4 in-context learning. Information on the existing datasets can be found in Sahar Kazemzadeh, Vicente Ordonez, Mark Matten, and Tamara Berg. Referitgame: Referring to objects in photographs of natural scenes. In EMNLP, 2014; Bryan A Plummer, Liwei Wang, Chris M Cervantes, Juan C Caicedo, Julia Hockenmaier, and Svetlana Lazebnik. Flickr30k entities: Collecting region-to-phrase correspondences for richer image-to-sentence models. In ICCV, 2015; Jingkang Yang, Yi Zhe Ang, Zujin Guo, Kaiyang Zhou, Wayne Zhang, and Ziwei Liu. Panoptic scene graph generation. In ECCV, 2022; and OpenAI. Gpt-4 technical report. arXiv:2303.08774, 2023, each incorporated herein by reference in their entirety. A high-quality dataset referred to as GranDf is also disclosed for fine-tuning.

TABLE 1
Comparison of conventional Large Multimodal Models (LMMs)

| | | Input/Output | | Region | Pixel-Wise | Multi-turn | End-End |
|---|---|---|---|---|---|---|---|
| Method | Image | Region | Multi-Region | Enc./Dec. | Grounding | Conversation | Model |
| MM-REACT (arXiv-23) | ✓ | X/X | X/X | X/X | X | ✓ | X |
| LLaVA (NeurIPS-23) | ✓ | X/X | X/X | X/X | X | ✓ | ✓ |
| miniGPT4 (arXiv-23) | ✓ | X/X | X/X | X/X | X | ✓ | ✓ |
| mPLUG-OWL (arXiv-23) | ✓ | X/X | X/X | X/X | X | ✓ | ✓ |
| LLaMA-Adapter v2 (arXiv-23) | ✓ | X/X | X/X | X/X | X | ✓ | ✓ |
| Otter (arXiv-23) | ✓ | X/X | X/X | X/X | X | X | ✓ |
| Instruct-BLIP (arXiv-23) | ✓ | X/X | X/X | X/X | X | ✓ | ✓ |
| InternGPT (arXiv-23) | ✓ | ✓/X | X/X | X/X | X | ✓ | X |
| Bubo-GPT (arXiv-23) | ✓ | X/✓ | X/✓ | X/X | X | ✓ | X |
| Vision-LLM (arXiv-23) | ✓ | X/✓ | X/✓ | X/X | X | X | ✓ |
| Det-GPT (arXiv-23) | ✓ | ✓/✓ | ✓/✓ | X/X | X | ✓ | ✓ |
| Shikra (arXiv-23) | ✓ | ✓/✓ | X/X | X/X | X | X | ✓ |
| Kosmos-2 (arXiv-23) | ✓ | ✓/✓ | ✓/✓ | X/X | X | X | ✓ |
| GPT4Rol (arXiv-23) | ✓ | ✓/X | ✓/X | ✓/X | X | ✓ | ✓ |
| ASM (arXiv-23) | ✓ | ✓/X | X/X | ✓/X | X | X | ✓ |
| LISA (arXiv-23) | ✓ | X/✓ | X/X | X/✓ | ✓ | X | ✓ |
| GLaMM (ours) | ✓ | ✓/✓ | ✓/✓ | ✓/✓ | ✓ | ✓ | ✓ |

The comparison of LMMs in Table 1 emphasizes their capabilities for region-level understanding. The Input denotes models that can process regions defined by users via bounding boxes, with Multi-Region indicating models that can handle multiple such regions. The Output represents models capable of delivering grounded responses. While some methods employ external vision modules for region understanding, others rely solely on the LMM, which may result in imprecise localization. However, a few integrate specialized vision modules and LMMs, as indicated by the Region Enc./Dec. The End-End Model distinction separates models that leverage LMMs for region understanding from those employing external modules. Pixel-wise Grounding highlights models that can respond with segmentation masks, and Multi-turn Conversation represents models that can hold an interactive dialogue with the user. Among these, the disclosed GLaMM stands out by offering comprehensive region understanding, pixel-wise grounding in its responses, conversational capabilities, and an end-to-end training approach.

The disclosed methods and systems disclosed herein belong to the last category and distinctly offers pixel-level grounding together with multi-turn conversations and the flexibility to operate on both input images and specific regions. Further, a large-scale instance-level grounded visual understanding dataset allows generalizability of GLaMM to multiple vision-language tasks.

### Method

As exhibited by x's in Output column in Table 1, most conventional Large Multimodal Models (LMMs) either generate ungrounded text or are restricted by limitations such as single-object grounding (Region Input in Table 1), user-specified region inputs, or the lack of dense pixel-level object grounding (x's in Pixel-Wise Grounding of Table 1). As an example, an ungrounded large language model generates text based on the model's learning. Grounding AI in machine learning refers to the process of linking abstract knowledge in AI systems to tangible, real-world examples. The Grounding LMM (GLaMM) aims to overcome these limitations by generating natural language responses seamlessly integrated with object segmentation masks. This enables a visually grounded human-machine conversation.

### 1. GLaMM Architecture

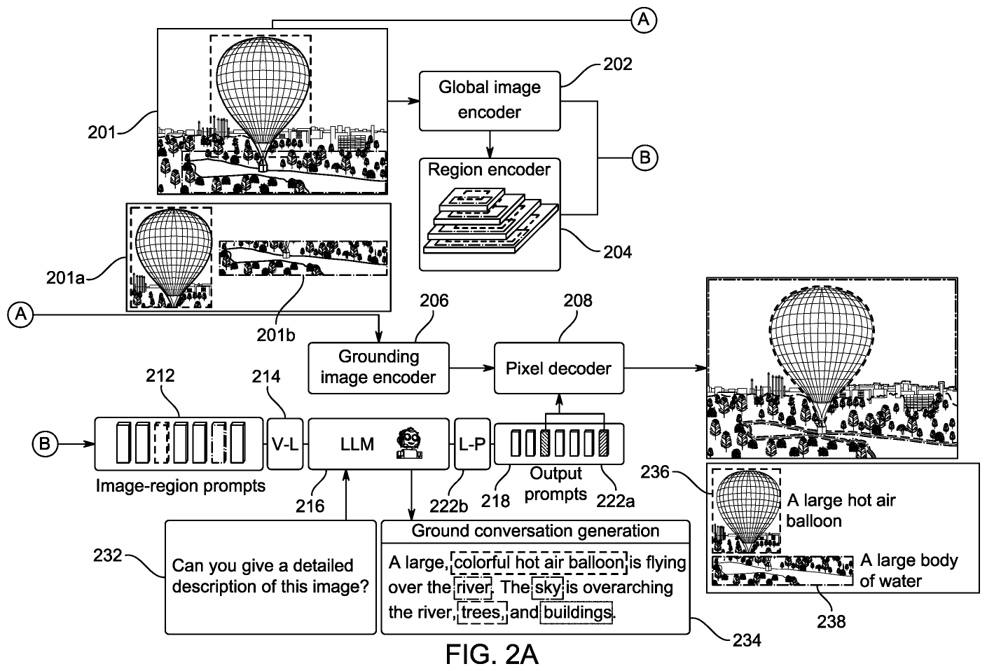

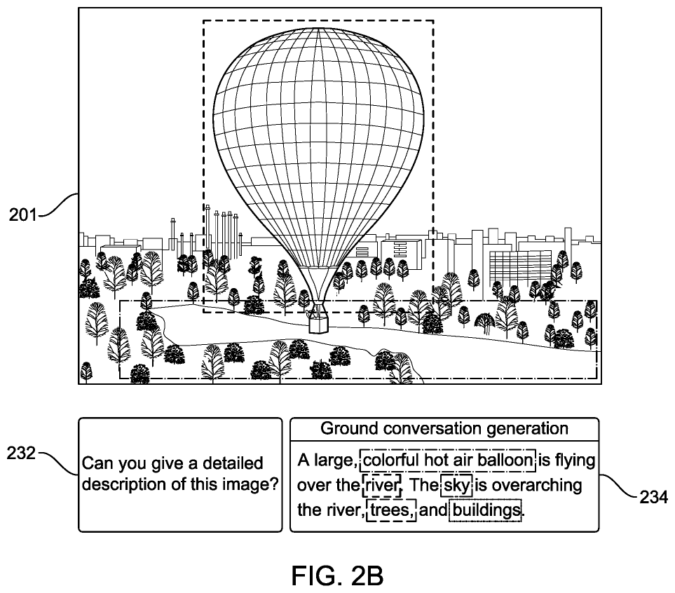

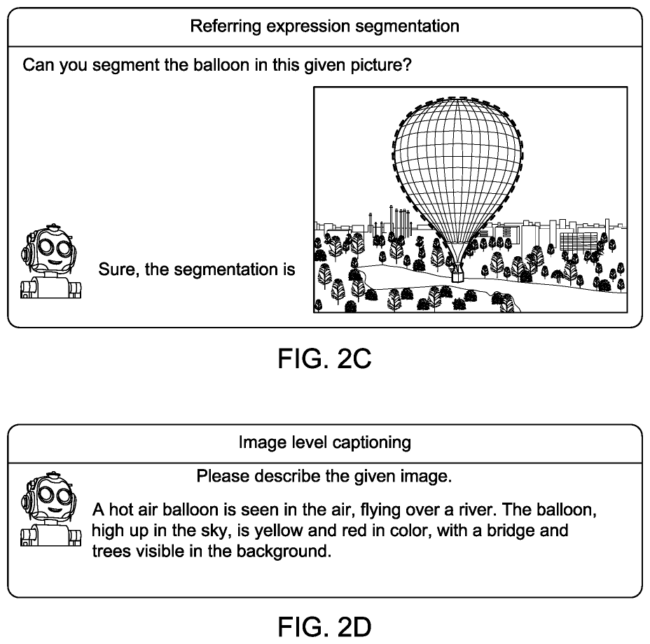

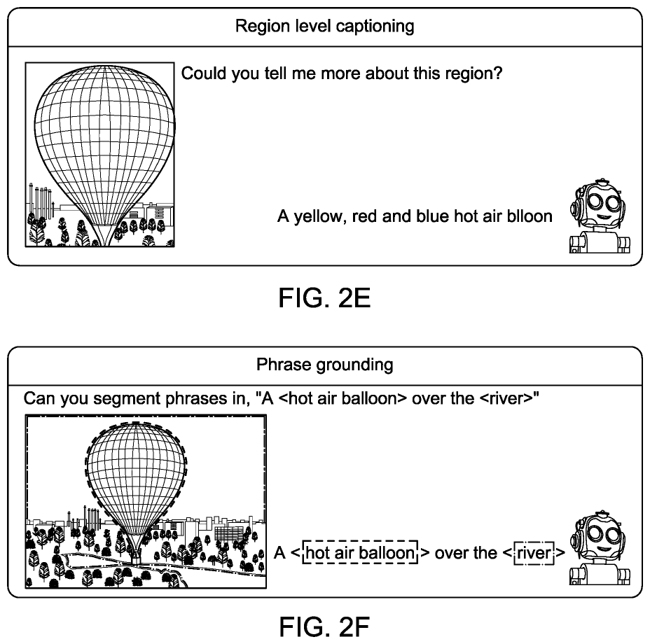

FIGS. 2A, 2B, illustrates the architecture of GLaMM GLaMM consists of five core components: i) Global Image Encoder 202, ii) Region Encoder 204, iii) LLM 216, iv) Grounding Image Encoder 206, and v) Pixel Decoder 208. These components are cohesively designed to handle both textual and optional visual prompts (image level and region), allowing for interaction at multiple levels of granularity and generating grounded text responses. These blocks together enable scene-level, region-level, and pixel-level grounding, as explained next. Training specifics are detailed later.

Scene-Level Understanding: To achieve a holistic understanding of the scene, ViT-H/14 CLIP (for Contrastive Language-Image Pre-training) is employed as a global image encoder ( [symbol] ) 202, in conjunction with a vicuna-based LLM ( [symbol] ) 216 and a vision-to-language (V-L) projection layer (f) 214. For a description of CLIP, see Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In ICML, 2021, incorporated herein by reference in its entirety. CLIP jointly trains an image encoder and a text encoder to predict the correct pairings of a batch of (image, text) training examples. At test time the learned text encoder synthesizes a zero-shot linear classifier by embedding the names or descriptions of the target dataset's classes. In GLaMM, given an image x_{img} 201 and a text instruction xₜ, 232 the image is first encoded into a feature vector Iₓ= [symbol] (x_{img})∈ [symbol] ^{D}^{ᵥ} and projected to language space f(Iₓ)∈ [symbol] ^{D}^{ₜ}. The LLM 216 then integrates both the projected image features and the text instruction to generate output yₜ 234:

$${y}_{t} = ℒ ( f ( {I}_{x} ) , {x}_{t} ) .$$

Vicuna is an open-source chatbot trained by fine-tuning LLaMA on user-shared conversations collected from ShareGPT. LLaMA is a family of autoregressive large language models (LLMs), released by Meta AI.

The global image encoder and LLM maps image features to language space, enabling GLaMM to offer holistic scene understanding, achieved through specific prompts like, “The <image> provides an overview of the image. Could you please give me a detailed description of the image?” The <image> token is replaced with 256 tokens from the CLIP global image encoder 202.

Region-Level Understanding: Building on the shortcomings of existing models that can handle only image-level visual inputs, the region encoder ( [symbol] ) 204 extends the model's capability to interpret and interact with user-specified regions 201a, 201b in an image. For background on region-level understanding. This component constructs a hierarchical feature pyramid from four selected CLIP global image encoder layers, followed by RoIAlign to generate a 14×14 feature map. Information about RoIAlign is provided in Kaiming He, Georgia Gkioxari, Piotr Dollár, and Ross Girshick. Mask r-cnn. In ICCV, 2017, incorporated herein by reference in its entirety. An RoIAlign layer removes the quantization of RoIPool, properly aligning the extracted features with the input. The change avoids any quantization of the RoI boundaries. In particular, RoIAlign computes the value of each sampling point by bilinear interpolation from the nearby grid points on the feature map. No quantization is performed on any coordinates involved in the RoI, its bins, or the sampling points. Combining these features yields a unified region-of-interest (RoI) representation.

To facilitate region-targeted responses from GLaMM, the existing vocabulary is augmented with a specialized token <bbox>. This is integrated into a prompt like, “The <image> provides an overview of the image. Can you provide a detailed description of the region <bbox>?”. Here the <bbox> token is replaced with the RoI extracted features.

For the region-level understanding, alongside the global image features Iₓ, user-specified regions r 201a, 201b are taken as inputs, encoded as Rₓ= [symbol] (Iₓ, r), followed by projection to language space through the same V-L projection layer f 214 employed in scene-level understanding. The text instruction xₜ 232 is augmented by replacing <bbox> tokens with the corresponding region features to obtain

$${x}_{t}^{′} = [ {x}_{t} ← f ( {R}_{x} ) ] .$$

The LLM 216 then generates the output yₜ 234 as,

$${y}_{t} = ℒ ( f ( {I}_{x} ) , {x}_{t}^{′} ) .$$

Pixel-Level Grounding: [INVENTOR NOTE: How does the pixel decoder differ from the SAM decoder?] Utilizing the grounding image encoder 206 denoted as [symbol] and the pixel decoder 208 represented as [symbol] , GLaMM facilitates fine-grained pixel-level object grounding, allowing it to ground its responses visually. [symbol] 206 is instantiated with a pretrained SAM encoder and [symbol] 208 is designed based on a SAM decoder-like architecture.

The mask decoder of SAM (Segment Anything Model) maps an image embedding, prompt embeddings, and an output token to a mask. The mask decoder employs a modification of a Transformer decoder block followed by a dynamic mask prediction head. The modified decoder block uses prompt self-attention and cross-attention in two directions (prompt-to-image embedding and vice-versa) to update all embeddings. After running two blocks, the image embedding are upsampled and an MLP maps the output token to a dynamic linear classifier, which then computes the mask foreground probability at each image location.

To activate the pixel-level grounding, the GLaMM's vocabulary is augmented with a specialized token, <SEG>. Prompts, such as “Please segment the ‘man in red’ in the given image,” trigger the model to generate responses with corresponding <SEG> tokens. A language-to-prompt (L-P) projection layer (g) 218 transforms the last-layer embeddings corresponding to <SEG> tokens (l_{seg}) into the decoder's feature space 222a. Subsequently, [symbol] 208 produces binary segmentation masks [symbol] 222b,

$$M = 𝒫 ( g ( {l}_{seg} ) , 𝒱 ( {x}_{img} ) ) , s . t . , {M}_{i} ∈ \{ 0 , 1 \} .$$

As in FIG. 2B, an aspect of GLaMM is its ability to perform a Grounded Conversation Generation (GCG) task 234. This highlights the model's capability to anchor specific phrases to corresponding segmentation masks in the image. The diverse downstream applications of GLaMM, include FIG. 2C referring expression segmentation, FIG. 2D image-level captioning, FIG. 2E region-level captioning, and FIG. 2F phrase grounding.

In the case of referring expression segmentation (RES), given an image and a natural language expression that describes an object in the image, RES aims to find this target object and generate a segmentation mask for it.

Using an end-to-end training approach, GLaMM excels in region understanding 236, 238, pixel-level grounding, and conversational capabilities 234. However, due to the lack of standard benchmarks for the novel setting of generating visually grounded detailed conversations, a task is introduced, Grounded Conversation Generation (GCG), and a comprehensive evaluation protocol as explained next.

### 2. Grounded Conversation Generation (GCG)

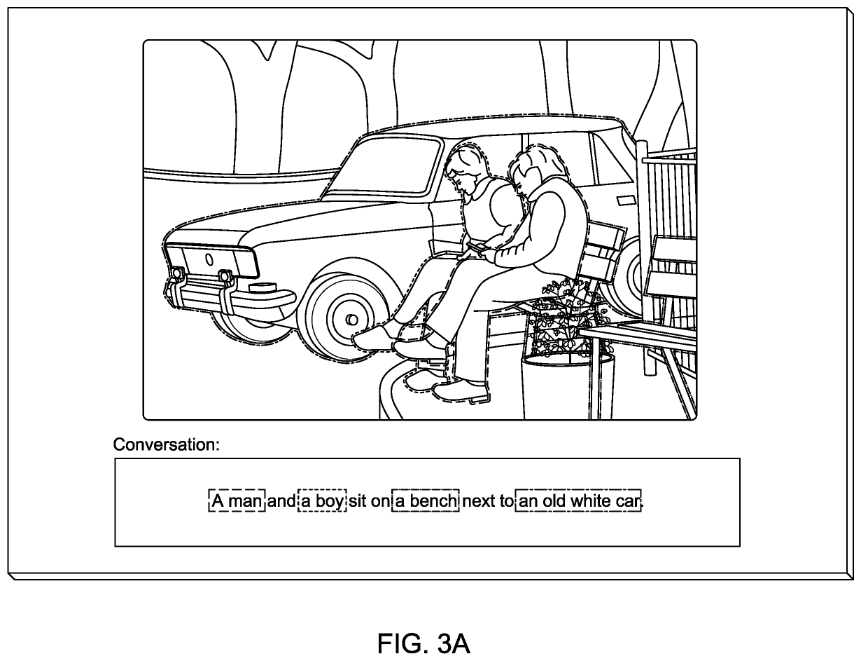

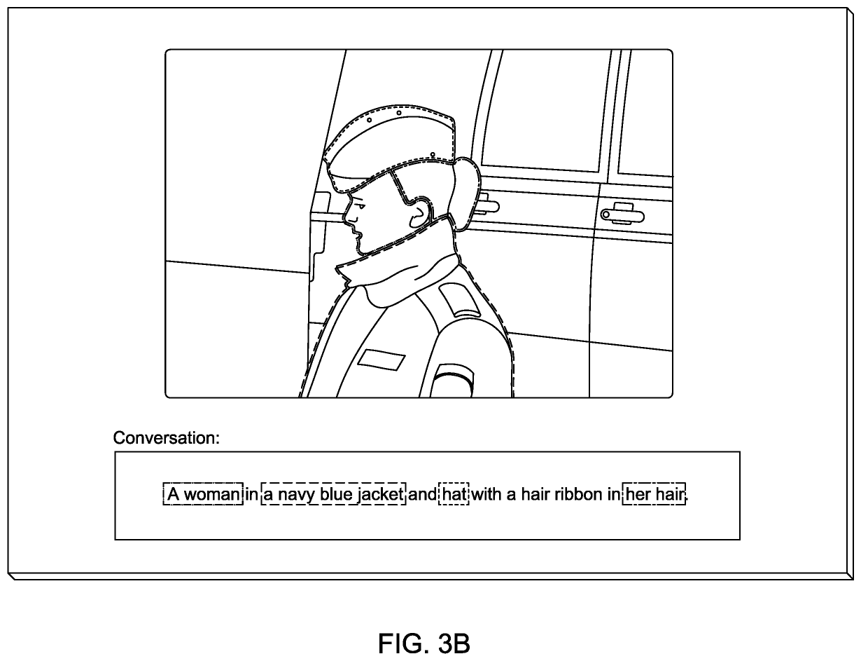

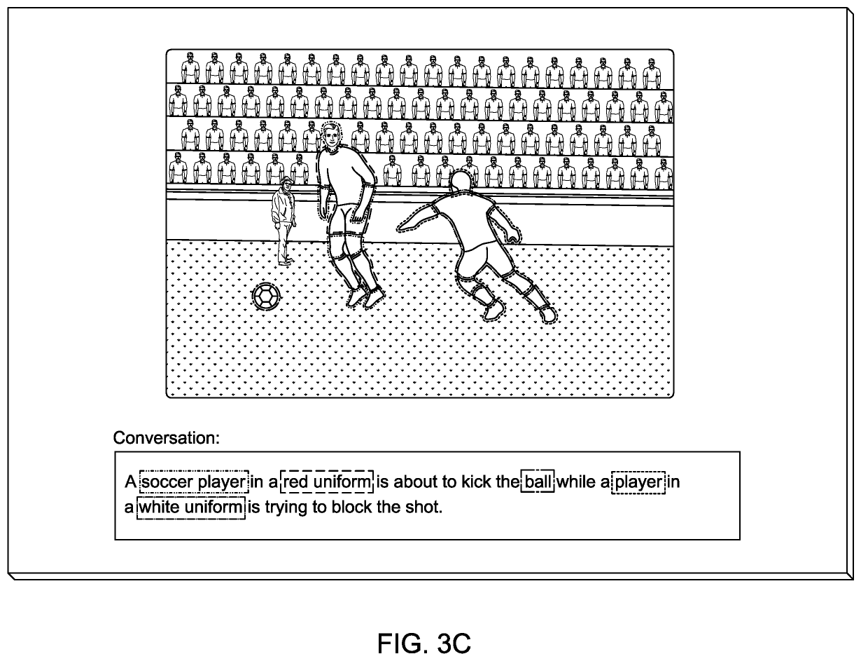

An objective of the GCG task is to construct image-level captions with specific phrases directly tied to corresponding segmentation masks in the image. For example, in FIG. 3A, “<A man> and <a boy> sit on <a bench> next to <an old white car>.”, features how each bracketed phrase (highlighted in the image) is anchored to a unique image segmentation mask. This creates a densely annotated caption that aligns textual descriptions with visual regions, enriching the image's contextual interpretation.

GCG Output Representation: A sample prompt for querying the model in the GCG task is: “Could you please give me a detailed description of the image? Please respond with interleaved segmentation masks for the corresponding parts of the answer.” The model generates a detailed caption along with interleaved segmentation masks, employing the format “<p>A man</p><SEG> and <p>a boy</p><SEG> sit on <p>a bench</p><SEG> next to <p>an old white car</p><SEG>.” Special tokens include <p>, </p> and <SEG>, to delineate the start and end of each phrase and its corresponding region mask, respectively.

The GranD dataset is constructed using a stage-wise annotation pipeline, capturing annotations that range from fine-grained specifics to high-level context. This enables the automatic generation of densely annotated captions well-suited for the GCG task, thereby significantly facilitating GLaMM's training for this task. Some qualitative results of the model on the GCG task are shown in FIG. 3A, 3B, 3C.

Evaluation Criteria: A benchmarking suite for GCG has a validation set of 2.5K images and a test set of 5K images. Four key aspects are evaluated: i) generated dense caption quality, ii) mask-to-phrase correspondence accuracy, iii) generated mask quality, and iv) region-specific grounding ability. Metrics include METEOR and CIDEr for captions, class-agnostic mask AP for grounding, mask IoU for segmentation, and mask recall for region-specific grounding.

Having delineated the architecture of GLaMM and the intricacies of the GCG task, it is imperative to address the scarcity of large-scale annotated data for region-level understanding. A new, densely annotated dataset is created to improve the model's performance and overcome this data limitation.

### Data Annotation Pipeline

An automated annotation pipeline is used to create the Grounding-anything Dataset (GranD). GranD is a comprehensive, multi-purpose image-text dataset offering a range of contextual information, from fine-grained to high-level details. It aims to overcome challenges in image understanding and dense pixel-level grounding, thereby expanding the capabilities of visual instruction tuning in LMMs.

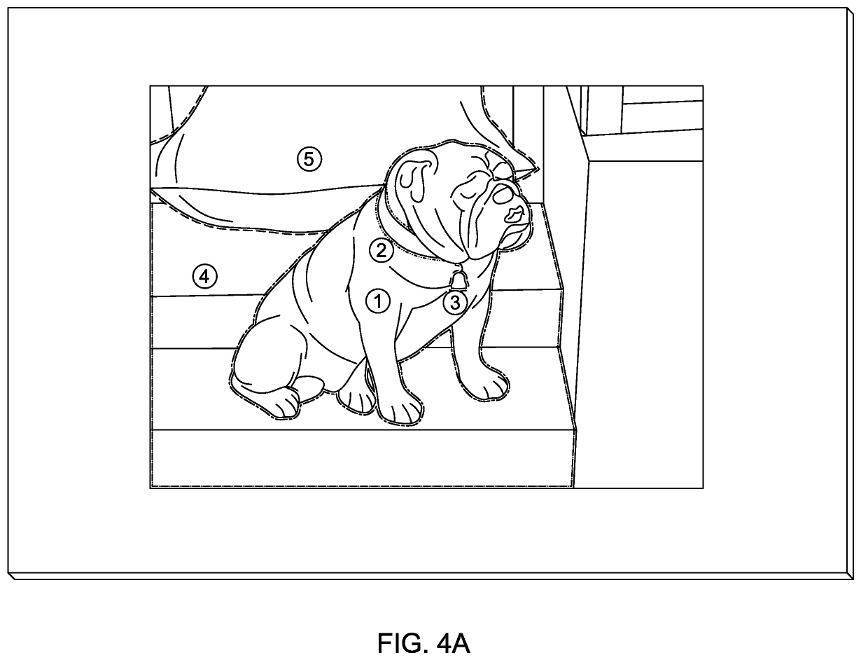

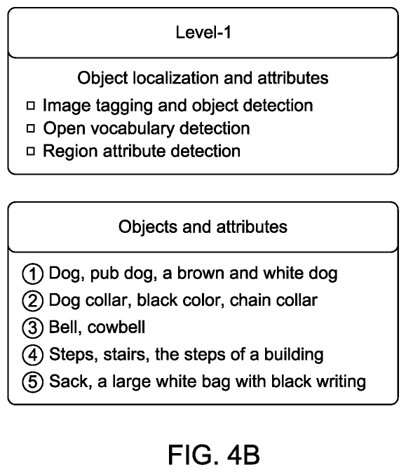

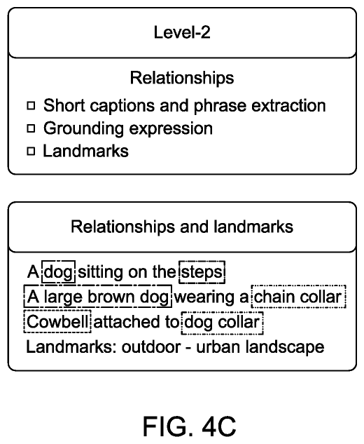

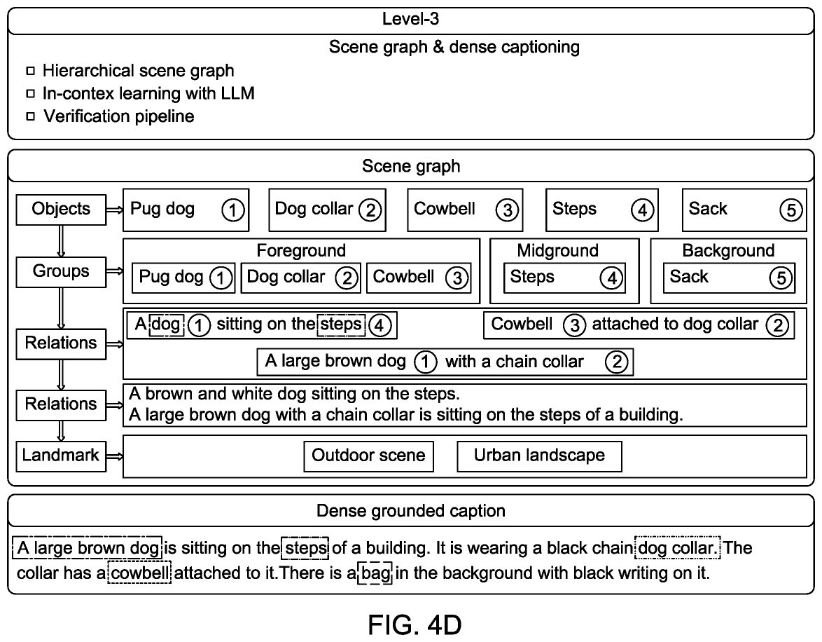

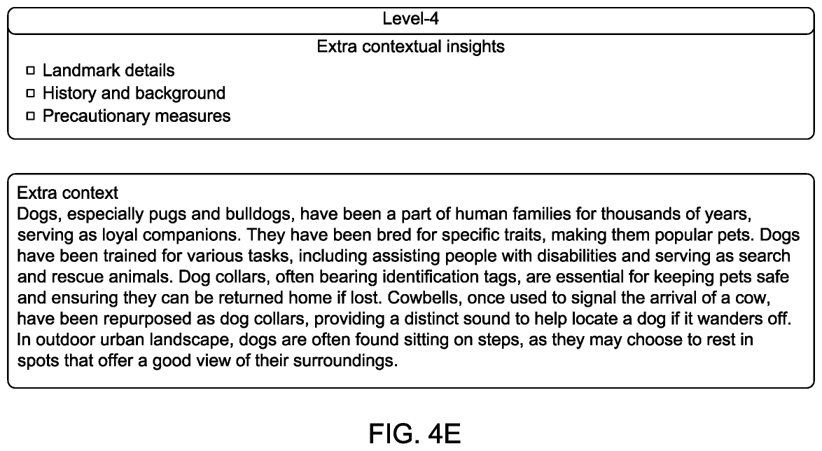

FIGS. 4A-4E illustrates an automatic annotation pipeline of a dataset, including FIG. 4B Level 1, FIG. 4C Level 2, FIG. 4D Level 3, FIG. 4E Level 4. FIG. 4A is a subject image.

i) Level-1 focuses on object localization and provides semantic labels, segmentation masks, attributes, and depth information. ii) Level-2 defines relationships between detected objects. iii) Level-3 organizes information from the first two levels into a hierarchical scene graph, used to generate dense captions using LLM with in-context examples. iv) Level-4 offers enriched contextual information for a deeper understanding of the scene, going beyond what's observed (e.g., historical information of a landmark).

### 1. Object Localization and Attributes (Level-1)

Referring to FIG. 4B, in level-1, the focus is on detailed object identification within images. First, object-bounding boxes are identified using multiple SoTA object detection models. Class-agnostic NMS is applied to each model to filter out false positives. After this step, bounding boxes from different models are compared using IoU, with a bounding box retained as an object only if detected by at least two other detection models. To generate attributes for each filtered object using region-based vision-language models and incorporate depth information to contextualize each object's relative position within the scene.

### 2. Relationships and Landmarks (Level-2)

Referring to FIG. 4C, in level-2, multiple short textual descriptions of the overall scene are generated. Phrases extracted from these descriptions are grounded to specific objects in level-1 to form relationships. These relationships articulate connections between multiple objects or define an object's role within the scene. Further, each scene is assigned a landmark category that includes a primary and a more specific sub-category.

### 3. Graph and Dense Captioning (Level-3)

Referring to FIG. 4D, in level-3, object attributes and labels from level-1 are combined with the relationships and phrases obtained from level-2 to form a hierarchical scene graph. This structured data serves as a query for LLM to generate dense image captions. To provide additional context, depth values and bounding box coordinates are used to assign each object to specific spatial layers within the scene, such as immediate foreground, foreground, midground, or background. Additionally, short scene-level captions are incorporated into the scene graph to enhance LLMs' contextual understanding. Dense Captioning Verification: To enhance the fidelity of the LLM-generated dense captions, an automatic verification pipeline is implemented using chain-of-thoughts prompting. This pipeline produces a checklist of objects derived from the generated dense caption that may be present in the image. The associated caption is flagged as inaccurate if any object specified in the checklist is absent from the scene graph. Such captions are then regenerated, incorporating feedback from the initial assessment.

### 4. Extra Contextual Insights (Level-4)

Referring to FIG. 4E, Level-4 builds on the scene graph from level-3 to obtain a more detailed visual understanding. LLM is queried to extract extended contextual insights beyond basic object identification and relationships, including details about the landmarks, historical context, guidelines for interacting with the scene, and even predictive elements about future events. To facilitate this, LLM is prompted with in-context examples.

TABLE 2
GranD versus conventional datasets.

| Dataset | Images | Regions | Concepts | Tokens | Captions^{†} |
|---|---|---|---|---|---|
| COCO | 0.1M | 0.9M | 80 | — | — |
| LVIS | 0.1M | 1.5M | 1,203 | — | — |
| Objects365 | 0.6M | 10.1M | 365 | — | — |
| Open Images | 1.5M | 14.8M | 600 | — | — |
| BigDetection | 3.5M | 36.0M | 600 | — | — |
| V3Det | 0.2M | 1.5M | 13,029 | — | — |
| VG | 0.1M | 0.3M | 18,136 | 51.2M | — |
| SA-1B | 11M | 1.1 B | — | — | — |
| [symbol] | [symbol] | [symbol] | [symbol] | [symbol] | — |
| GranD (Ours) | 11M | 810M | 7.5M | 5.0 B | 33M |

GranD uniquely provides three †grounded captions per image with segmentation masks for every region. AS-1B is shaded to denote its concurrent, non-public status at the time of this publication. The conventional datasets are provided in Tsung-Yi Lin, Michael Maire, Serge Belongie, James Hays, Pietro Perona, Deva Ramanan, Piotr Dollar, and C Lawrence Zitnick. Microsoft coco: Common objects in context. In ECCV, 2014; Agrim Gupta, Piotr Dollar, and Ross Girshick. Lvis: A dataset for large vocabulary instance segmentation. In CVPR, 2019; Shuai Shao, Zeming Li, Tianyuan Zhang, Chao Peng, Gang Yu, Xiangyu Zhang, Jing Li, and Jian Sun. Objects365: A large-scale, high-quality dataset for object detection. In ICCV, 2019; Alina Kuznetsova, Hassan Rom, Neil Alldrin, Jasper Uijlings, Ivan Krasin, Jordi Pont-Tuset, Shahab Kamali, Stefan Popov, Matteo Malloci, Alexander Kolesnikov, et al. The open images dataset v4: Unified image classification, object detection, and visual relationship detection at scale. IJCV, 2020; Likun Cai, Zhi Zhang, Yi Zhu, Li Zhang, Mu Li, and Xiangyang Xue. Bigdetection: A large-scale benchmark for improved object detector pre-training. In CVPR, 2022; Jiaqi Wang, Pan Zhang, Tao Chu, Yuhang Cao, Yujie Zhou, Tong Wu, Bin Wang, Conghui He, and Dahua Lin. V3det: Vast vocabulary visual detection dataset. arXiv:2304.03752, 2023; Ranjay Krishna, Yuke Zhu, Oliver Groth, Justin Johnson, Kenji Hata, Joshua Kravitz, Stephanie Chen, Yannis Kalantidis, Li-Jia Li, David A Shamma, et al. Visual genome: Connecting language and vision using crowdsourced dense image annotations. IJCV, 2017, each incorporated herein by reference in their entirety.

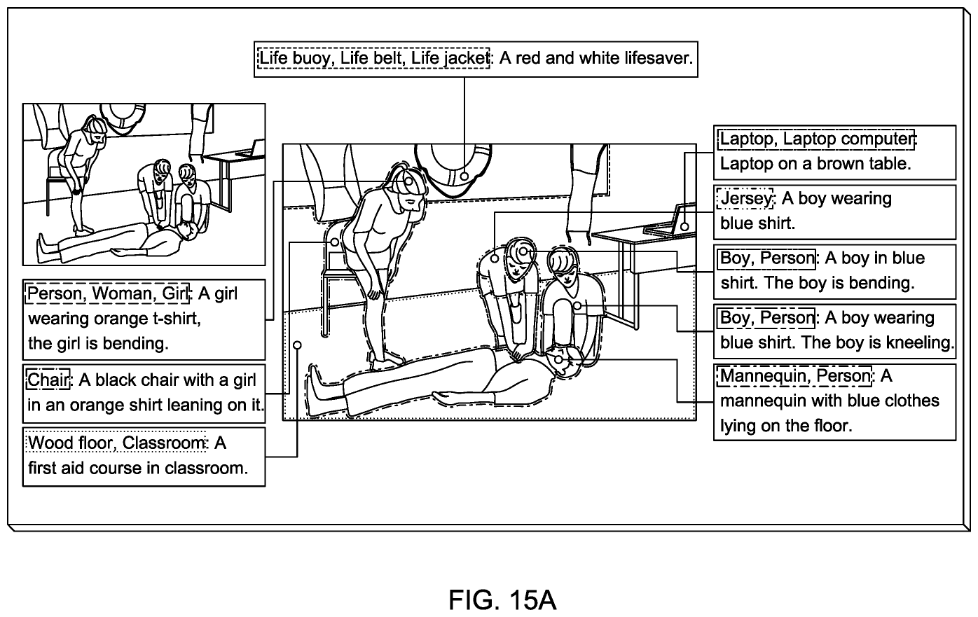

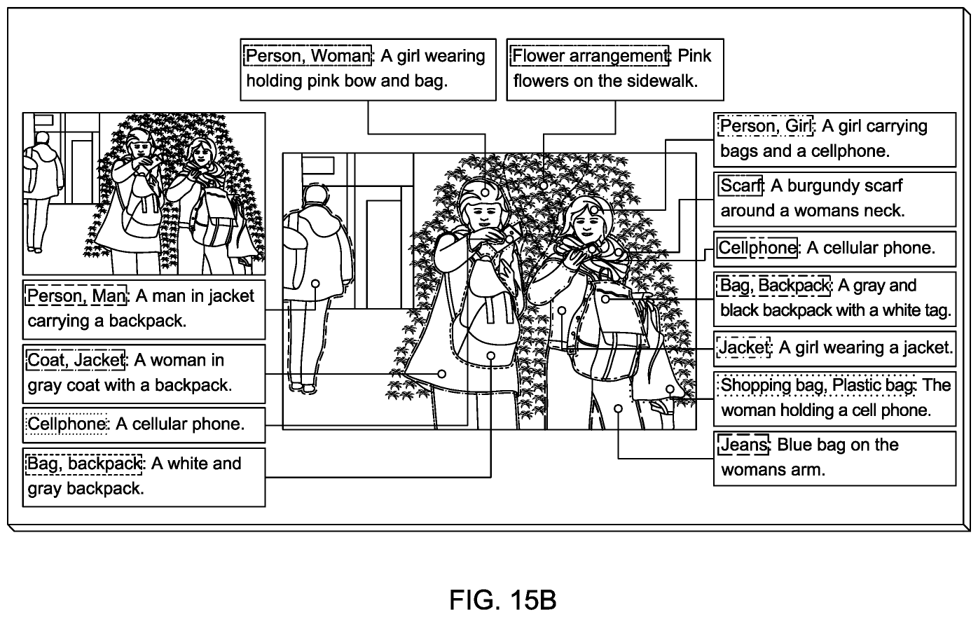

Utilizing the automated annotation pipeline, a corpus of 11M SAM images are annotated, which are inherently diverse, high-resolution, and privacy-compliant. For information on SAM images. The resulting dataset comprises 810M regions, each associated with a segmentation mask, and includes 7.5M unique concepts. Further, the dataset features 84M referring expressions, 22M grounded short captions, and 11M densely grounded captions. The GranD dataset is generated entirely through an automated annotation pipeline (see FIG. 15A, 15B for dataset sample visualizations).

### 5. Building GranD_{f} for GCG

Motivated by the need for higher-quality data in fine-tuning stage, GranD_{f} is introduced that contains 214K image-grounded text pairs with 2.5K validation and 5K test samples. GranD_{f} comprises two primary components: one subset is manually annotated, and the other subset is derived by re-purposing existing open-source datasets.

TABLE 3
GLaMM Performance on GCG Task: Metrics include METEOR (M), CIDEr
(C), AP50, mIoU, and Mask Recall. LISA* indicates a modified
LISA adapted for GCG. GlaMM shows better performance.

| | Validation Set | | | | | Test Set | | | | |
|---|---|---|---|---|---|---|---|---|---|---|
| Model | M | C | AP50 | mIoU | Recall | M | C | AP50 | mIoU | Recall |
| BuboGPT | 17.2 | 3.6 | 19.1 | 54.0 | 29.4 | 17.1 | 3.5 | 17.3 | 54.1 | 27.0 |
| Kosmos-2 | 16.1 | 27.6 | 17.1 | 55.6 | 28.3 | 15.8 | 27.2 | 17.2 | 56.8 | 29.0 |
| LISA* | 13.0 | 33.9 | 25.2 | 62.0 | 36.3 | 12.9 | 32.2 | 24.8 | 61.7 | 35.5 |
| GLaMM | 13.4 | 34.2 | 26.4 | 62.1 | 37.4 | 13.1 | 34.1 | 25.2 | 62.0 | 36.0 |

TABLE 4
Qualitative Assessment of GLaMM in Referring-
Expression Segmentation: Performance across
refCOCO, refCOCO+, and refCOCOg

| | | | | | | | refCOCOg | |
|---|---|---|---|---|---|---|---|---|
| | refCOCO | | | refCOCO+ | | | val | test |
| Method | val | testA | testB | val | testA | testB | (U) | (U) |
| CRIS | 70.5 | 73.2 | 66.1 | 65.3 | 68.1 | 53.7 | 59.9 | 60.4 |
| LAVT | 72.7 | 75.8 | 68.8 | 62.1 | 68.4 | 55.1 | 61.2 | 62.1 |
| GRES | 73.8 | 76.5 | 70.2 | 66.0 | 71.0 | 57.7 | 65.0 | 66.0 |
| X-Decoder | — | — | — | — | — | — | 64.6 | — |
| SEEM | — | — | — | — | — | — | 65.7 | — |
| LISA-7B | 74.9 | 79.1 | 72.3 | 65.1 | 70.8 | 58.1 | 67.9 | 70.6 |
| GLaMM | 78.3 | 81.5 | 74.4 | 68.0 | 75.7 | 61.8 | 72.5 | 72.0 |

Generating accurate segmentation masks based on text-based referring expressions surpasses that of closely related work, including LISA which is specifically designed for this task. Conventional methods of expression segmentation are found in Zhaoqing Wang, Yu Lu, Qiang Li, Xunqiang Tao, Yandong Guo, Mingming Gong, and Tongliang Liu. Cris: Clip-driven referring image segmentation. In CVPR, 2022; Zhao Yang, Jiaqi Wang, Yansong Tang, Kai Chen, Hengshuang Zhao, and Philip HS Torr. Lavt: Language-aware vision transformer for referring image segmentation. In CVPR, 2022; Chang Liu, Henghui Ding, and Xudong Jiang. Gres: Generalized referring expression segmentation. In CVPR, 2023; Xueyan Zou, Zi-Yi Dou, Jianwei Yang, Zhe Gan, Linjie Li, Chunyuan Li, Xiyang Dai, Harkirat Behl, Jianfeng Wang, Lu Yuan, et al. Generalized decoding for pixel, image, and language. In CVPR, 2023; Xueyan Zou, Jianwei Yang, Hao Zhang, Feng Li, Linjie Li, Jianfeng Gao, and Yong Jae Lee. Segment everything everywhere all at once. In NeurIPS, 2023; and Lai et al., each incorporated herein by reference in their entirety.

Open-source datasets—namely Flickr-30K, RefCOCOg, and PSG can be obtained by generating compatible GCG annotations. For RefCOCOg, the dataset's referring expressions are used and their connected masks. These expressions offer concise descriptions of distinct objects in the image. With the aid of GPT-4, these referring expressions are seamlessly blended with contextual information from COCO captions, crafting detailed yet accurate grounded captions while preserving the original referring expressions. This ensures zero error in matching phrases with their corresponding segmentation masks. This technique yields approximately 24K GCG samples. For PSG, leverage the dataset's triplet structures, which describe relations between two objects in a scene. These triplets are integrated with COCO captions using GPT-4, resulting in densely annotated captions that can be mapped to segmentation masks. This gives around 31K additional GCG samples. For Flickr-30K, use the 158K Flickr captions and their referring expressions alongside associated bounding boxes. These boxes are then accurately segmented using HQ-SAM. HQ-SAM is described in Lei Ke, Mingqiao Ye, Martin Danelljan, Yifan Liu, Yu-Wing Tai, Chi-Keung Tang, and Fisher Yu. Segment anything in high quality. arXiv:2306.01567, 2023, incorporated herein by reference in its entirety.

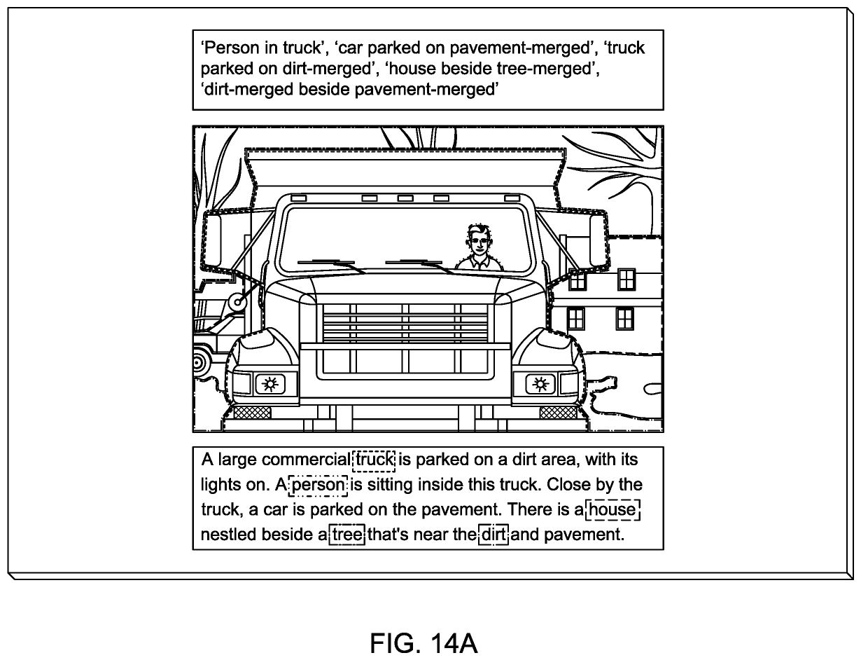

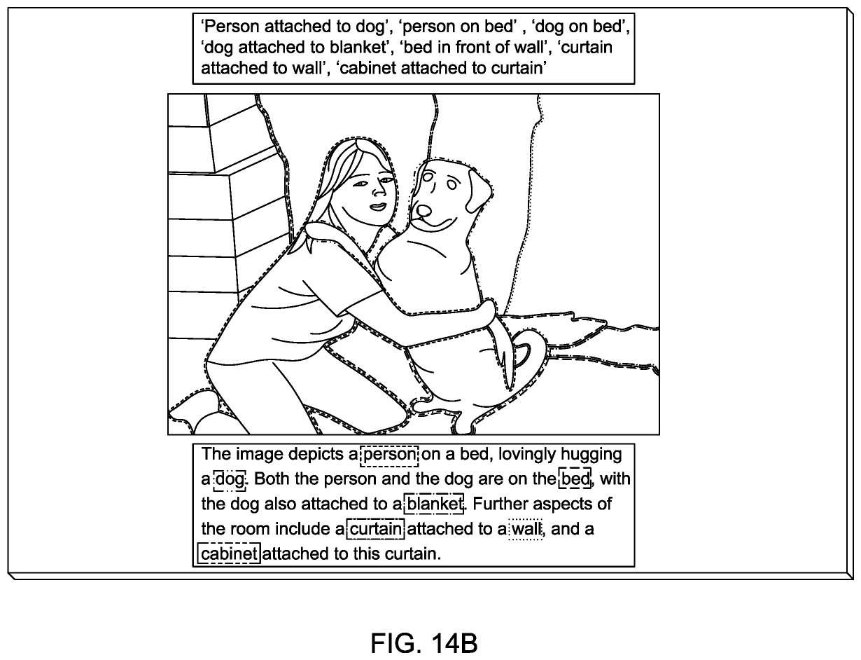

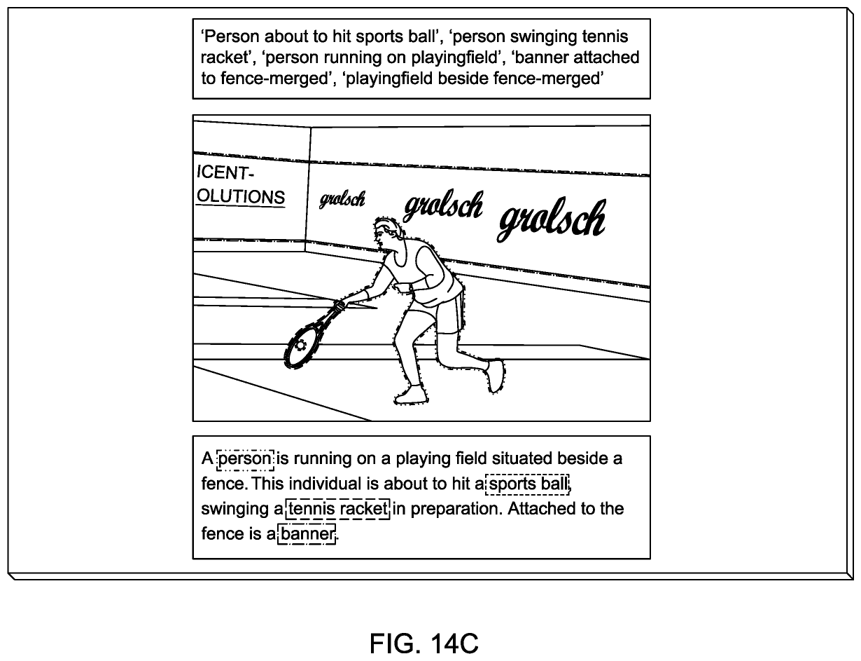

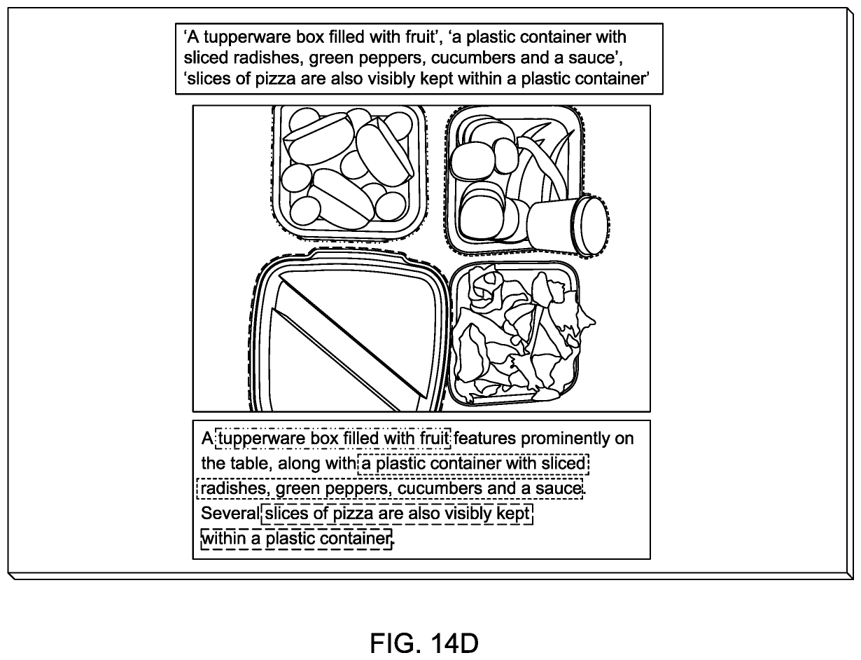

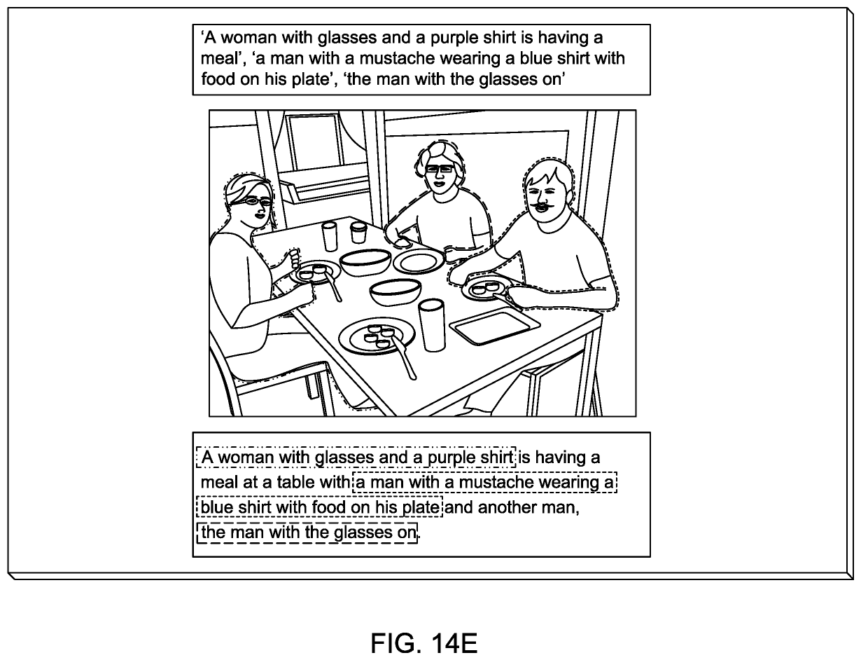

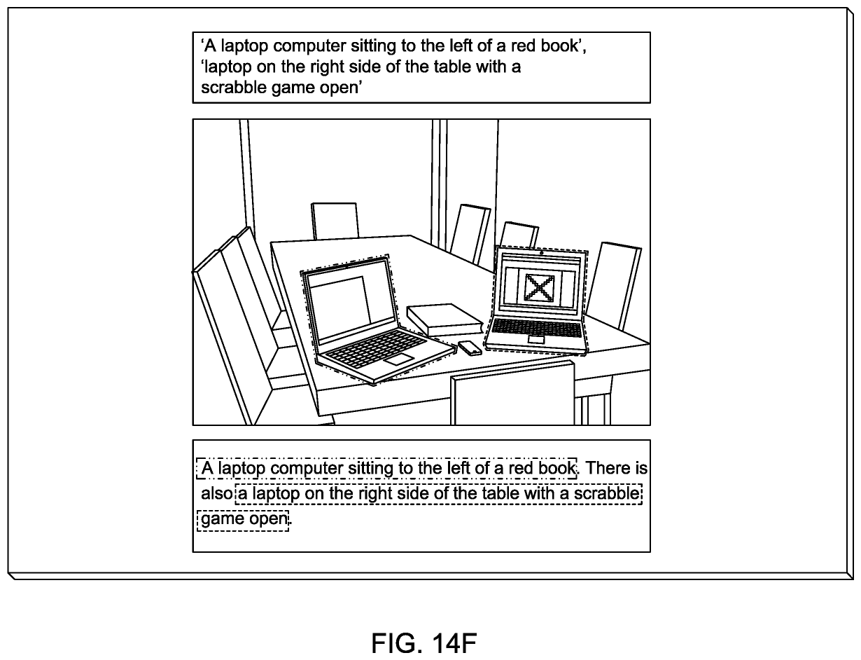

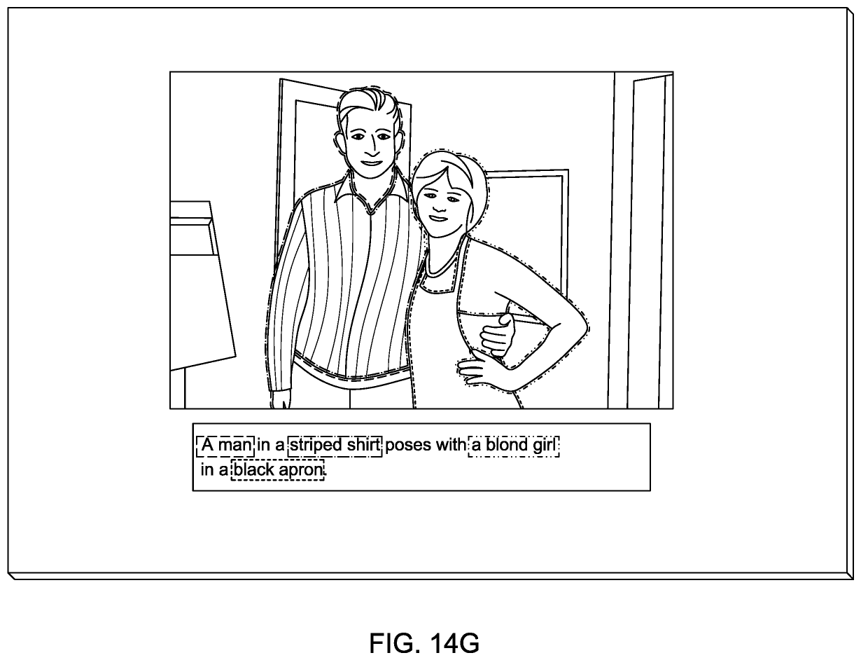

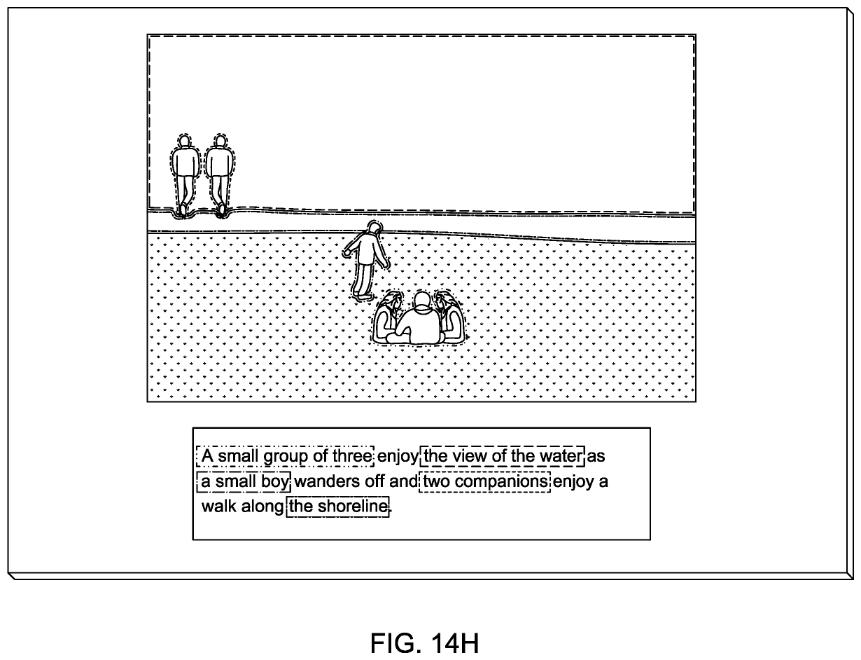

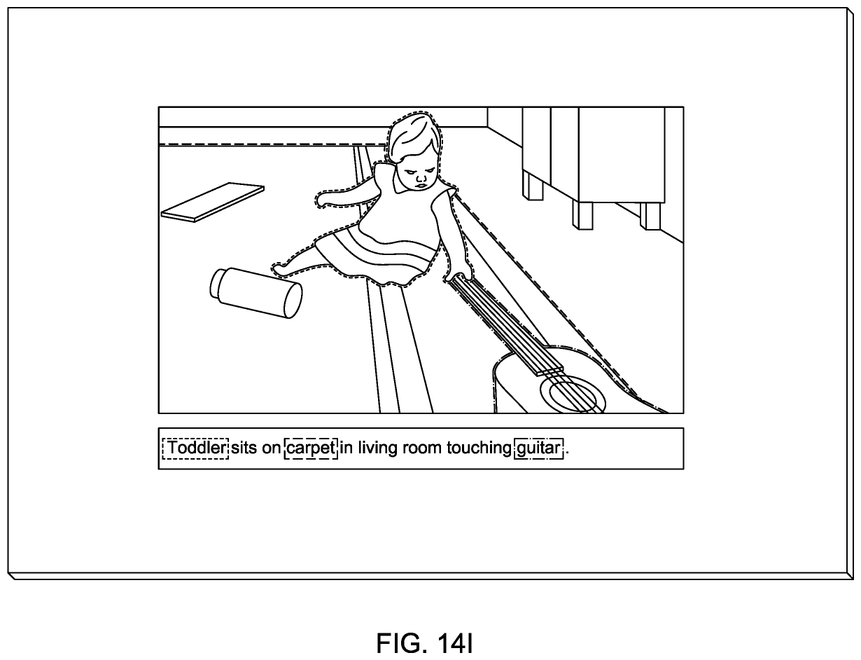

In addition, a high-quality manual annotation is set to benchmark the GCG task. Using GranD's automatic annotations as a base, annotators refine referring expressions to match SAM GT masks, yielding around 1000 focused samples for evaluation (refer to FIG. 14A-14I for designed prompts and dataset visualizations).

### Experiments

Quantitative evaluations of GLaMM are performed on six benchmarks: i) Grounded Conversation Generation (GCG), ii) referring-expression segmentation, iii) region-level captioning, iv) image-level captioning, v) conversational-style question answering and vi) phrase grounding.

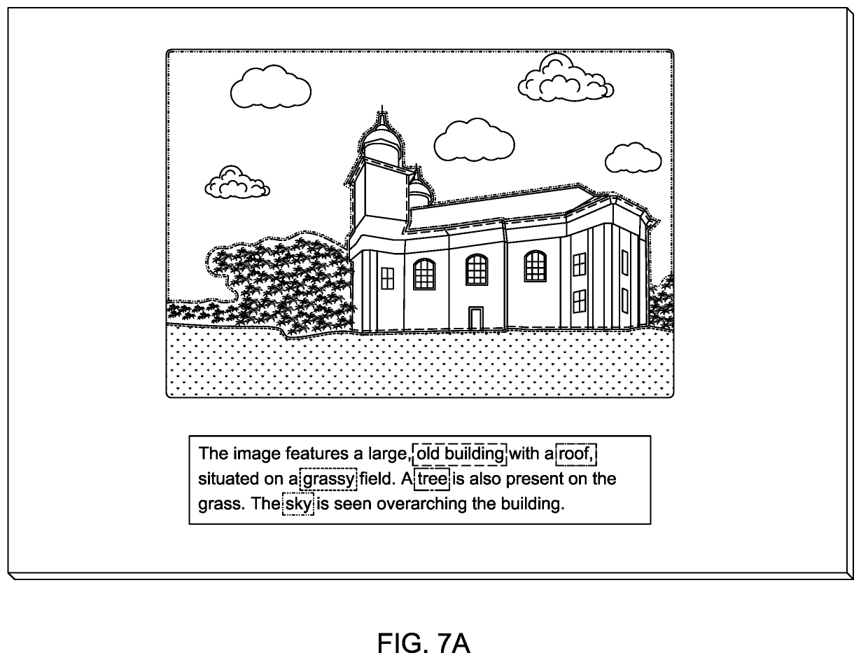

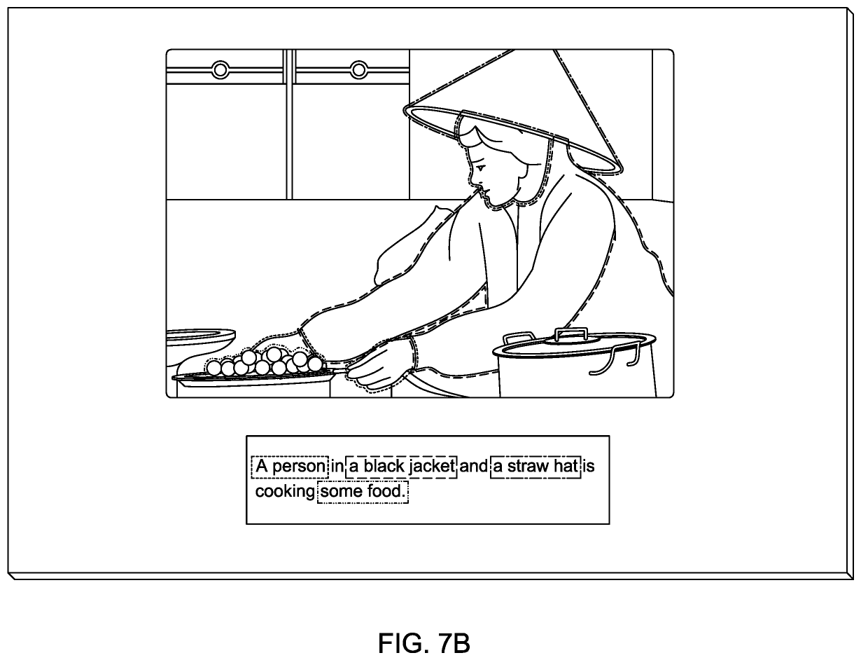

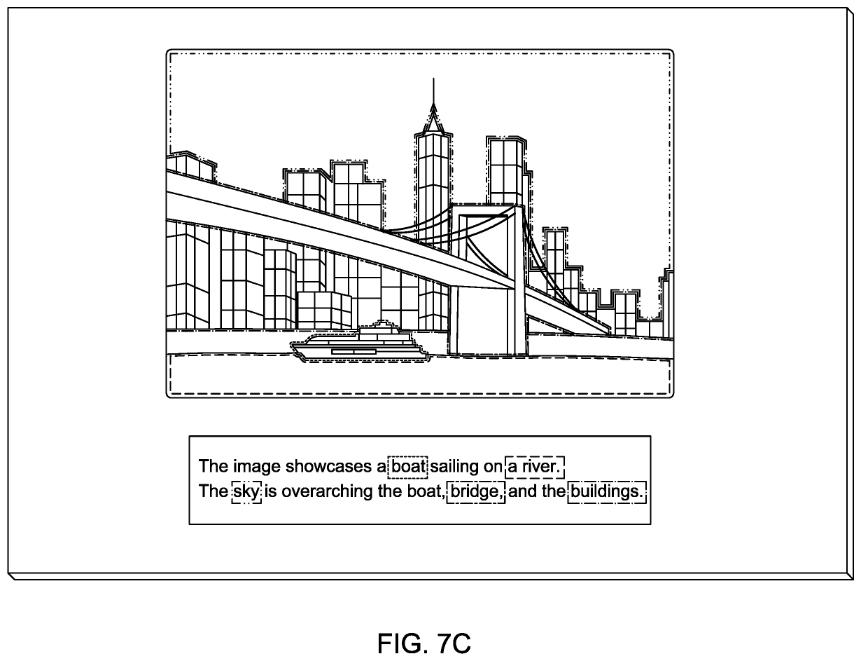

Grounded Conversation Generation (GCG). GLaMM is pretrained on GranD dataset followed by fine-tuning on the GranDf dataset. The results are presented in Table 3 on both validation and test splits of the GranDf dataset. GLaMM shows improved performance compared to baseline methods. Pretrained models for BuboGPT and Kosmos-2 are sourced from official releases, and LISA is adapted and trained on the GranDf dataset for the GCG task. Qualitative results are shown in FIGS. 3A, 3B, 3C and FIGS. 7A, 7B, 7C. The figures show how GLaMM seamlessly generates detailed responses and grounding phrases using pixel-level masks. Referring to FIGS. 3A, 3B, 3C, given user queries, the LMM generates textual responses and grounds objects, object parts, attributes, and phrases using pixel-level masks, showing its detailed understanding.

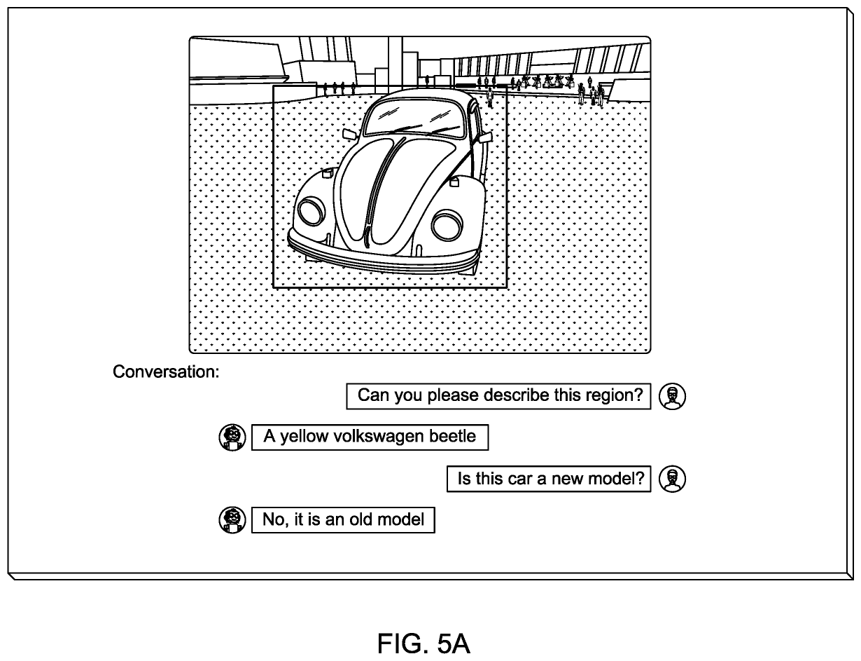

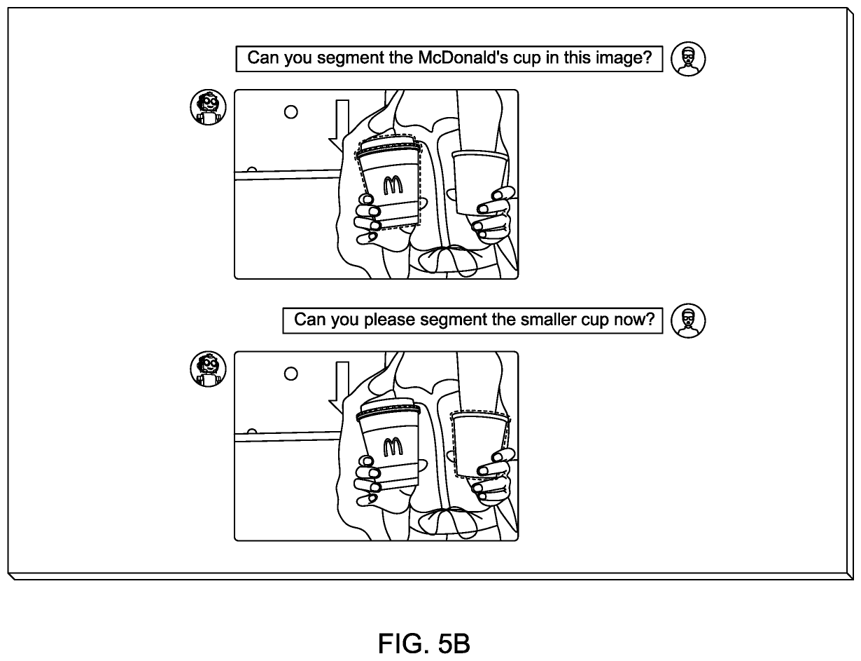

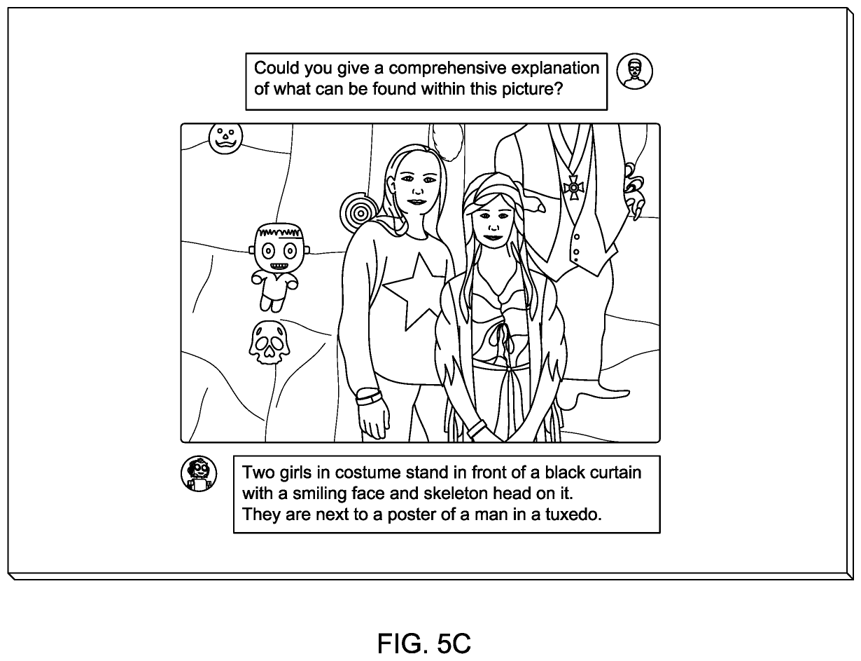

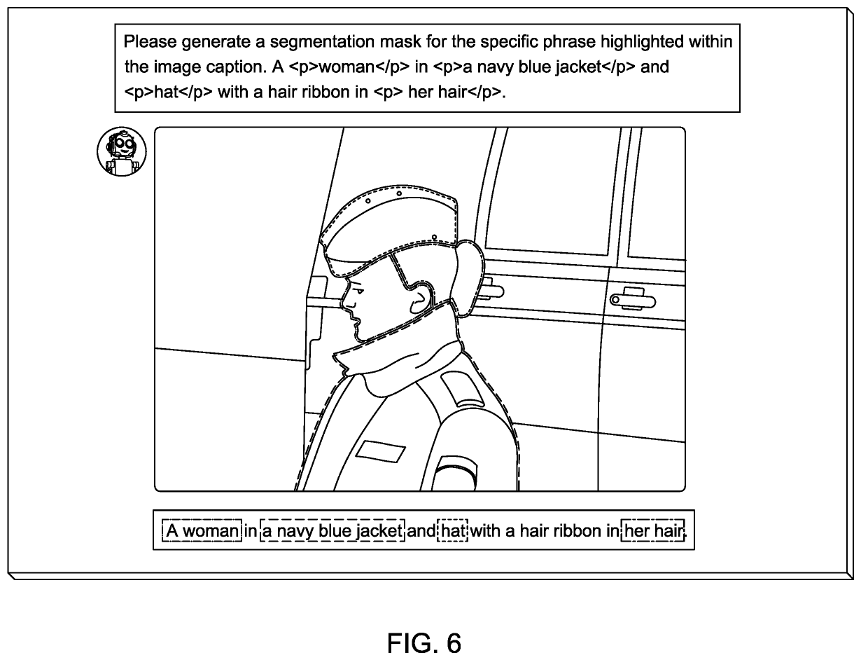

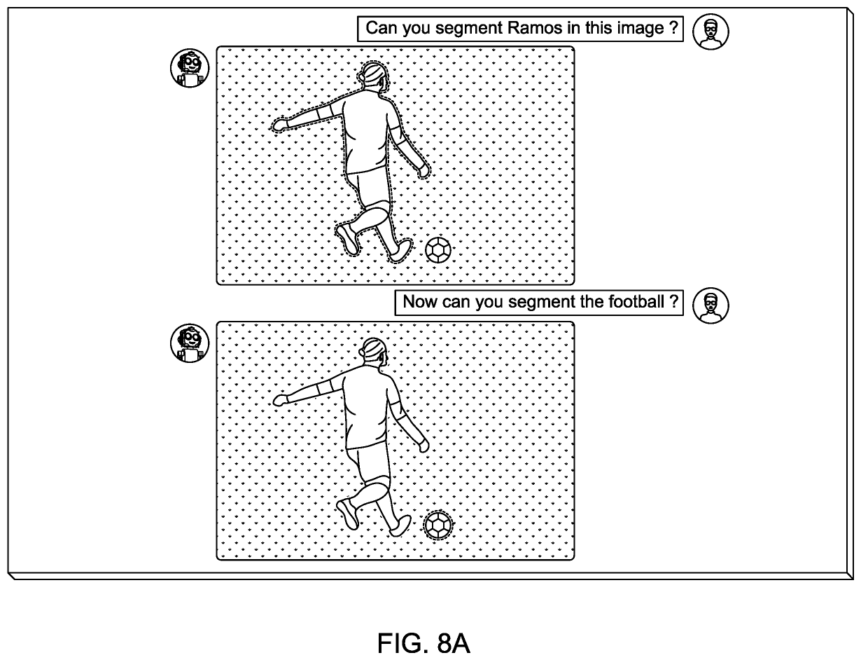

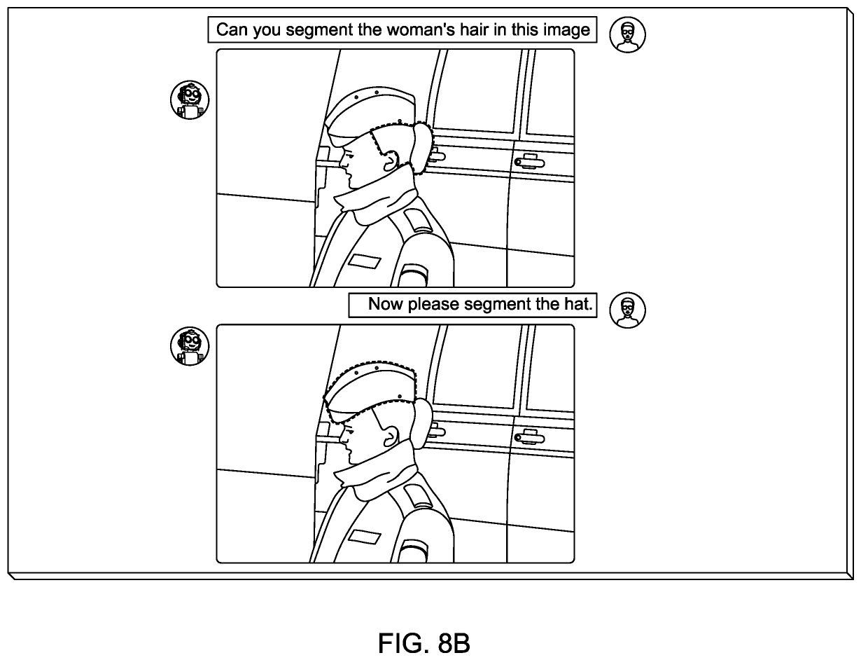

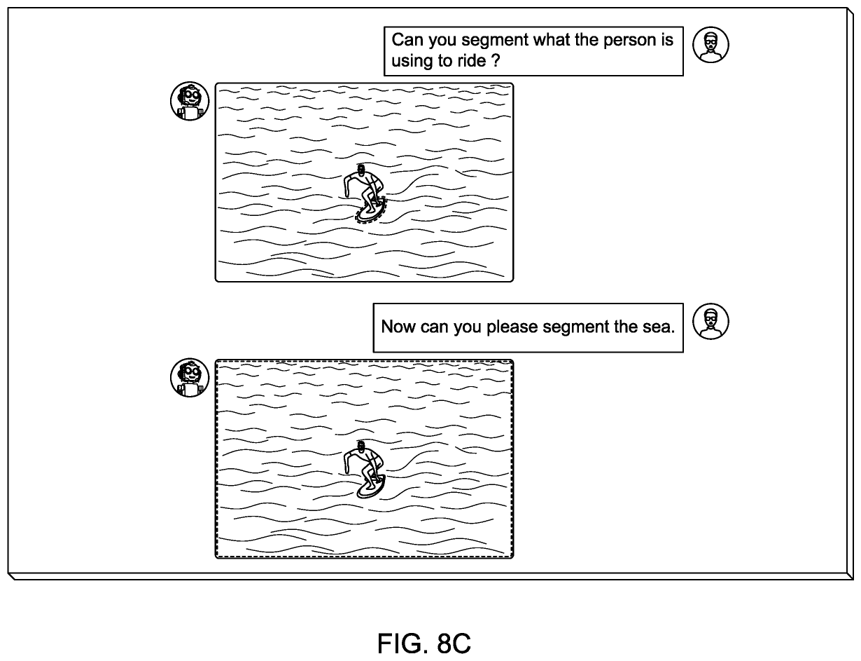

Referring Expression Segmentation. FIG. 5B illustrates qualitative results for a referring-expression segmentation task. In this task, the model processes an image and a text-based referring expression to output a segmentation mask. The prompt used is, “Please segment the <referring expression> in the image.” The model responds with “Sure, it is <SEG>.”, where the <SEG> token is decoded to obtain the mask. Better results are achieved over recent works like LISA on the refCOCO, refCOCO+, and refCOCOg validation and test sets in Table. 4. This demonstrates the efficacy of the GranD dataset, offering the model extensive concept vocabulary during pre-training (refer also to FIGS. 8A, 8B, 8C for qualitative results). The figures illustrate how GLaMM effectively translates text-based referring expressions into corresponding segmentation masks. Leveraging its training on the GranD dataset, the model can provide pixel-grounded reasoning and operate across various levels of granularity.

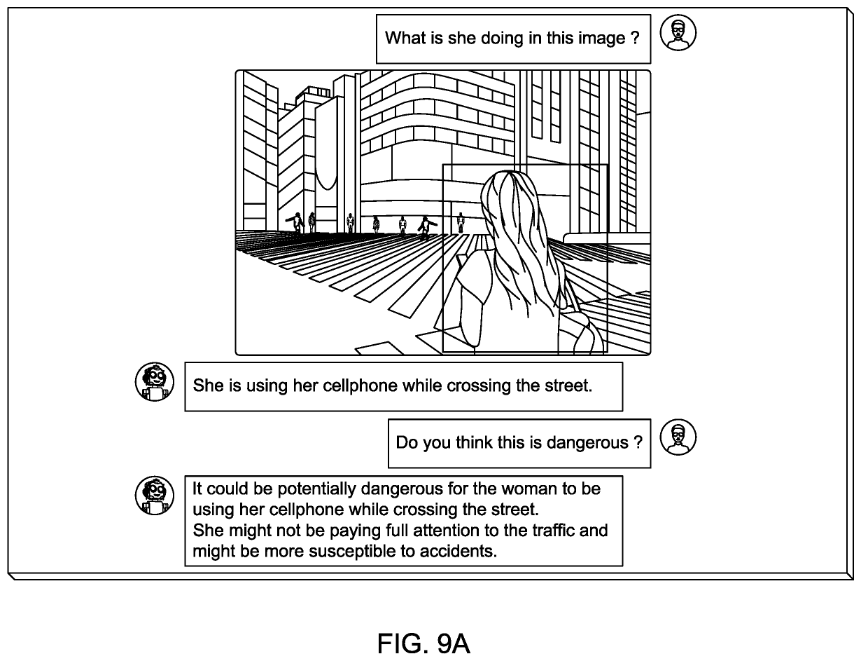

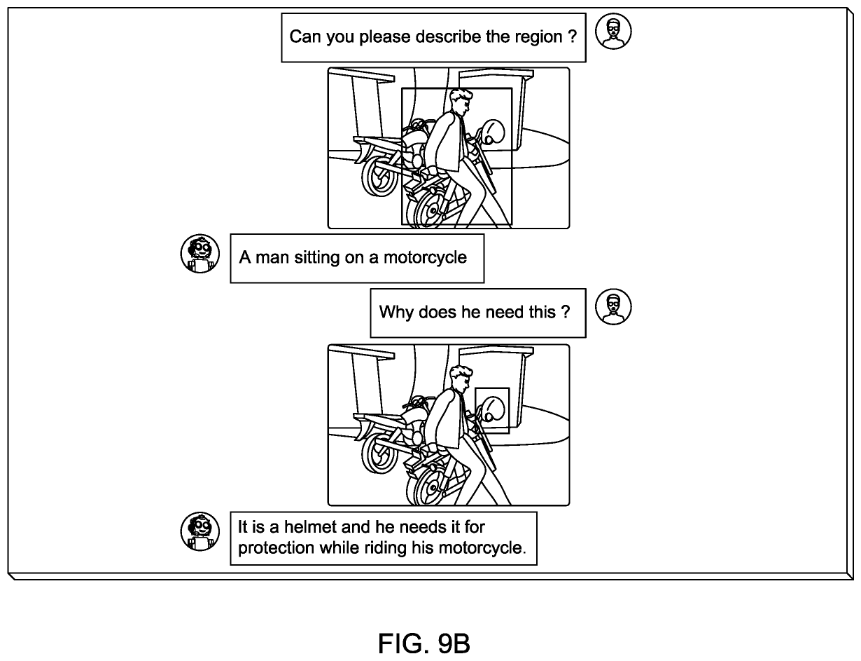

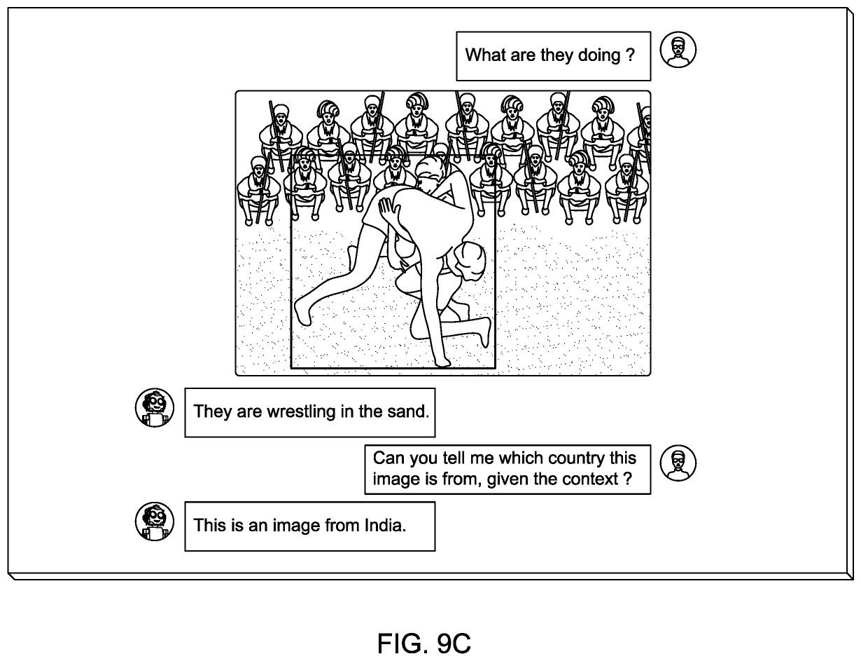

Region Level Captioning. FIG. 5A illustrates qualitative results for a region-level understanding task. In this task, models generate region-specific captions given an image, a user-specified region via a bounding box and related text. A prompt like, “Can you provide a detailed description of the region <bbox>?”, is utilized to instruct the model for this task, where the special token <bbox> is replaced with the actual region representations. GLaMM is evaluated on Visual Genome and refCOCOg, using METEOR and CIDEr metrics with results presented in Table. 5. GLaMM shows improved results over GRIT and GPT4RoI after fine-tuning and demonstrates robust zero-shot performance, highlighting the significance of GranD's region-text pairs (see also FIGS. 9A, 9B, 9C for qualitative results). The figures demonstrate GLaMM's ability to generate region-specific captions adeptly, translating the intricate details from designated regions into coherent textual descriptions, enriched by its training on the comprehensive GranD dataset. This capability, combined with the inherent reasoning abilities of LLMs, enables it to tackle reasoning-based visual questions about these regions.

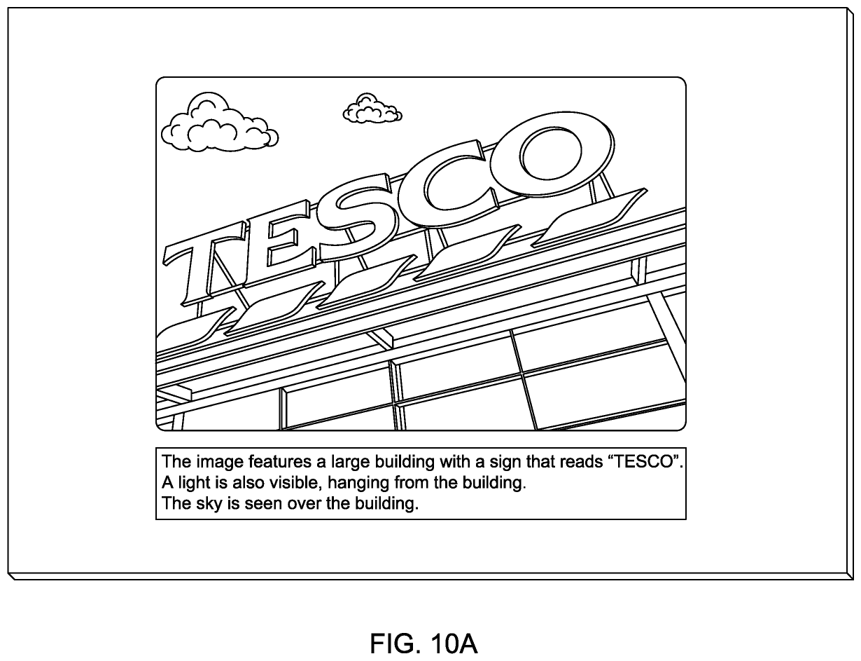

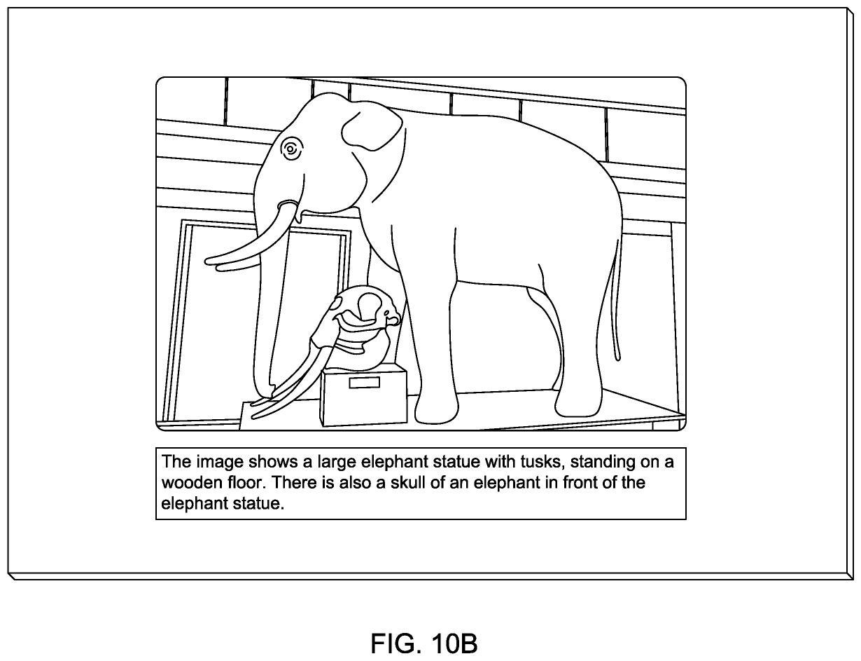

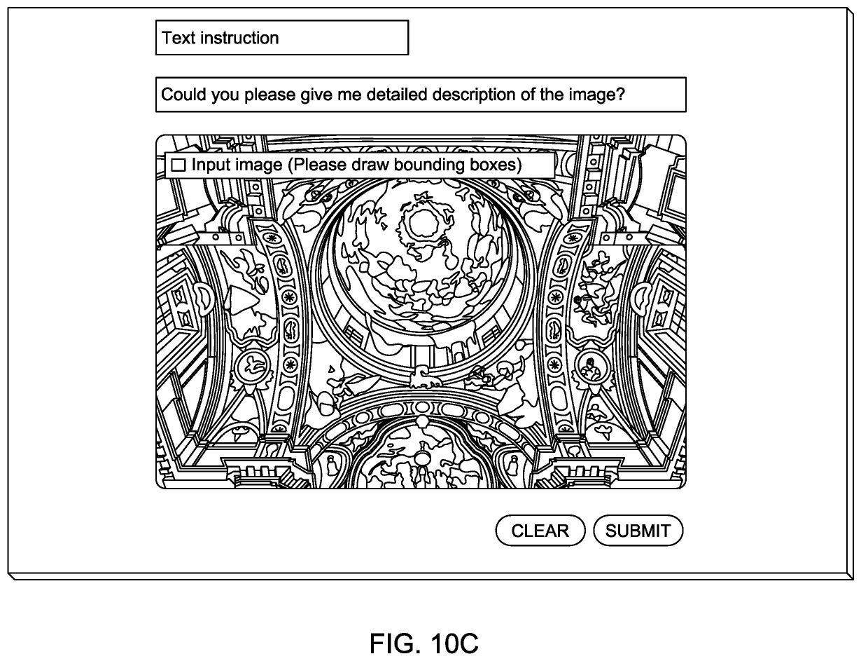

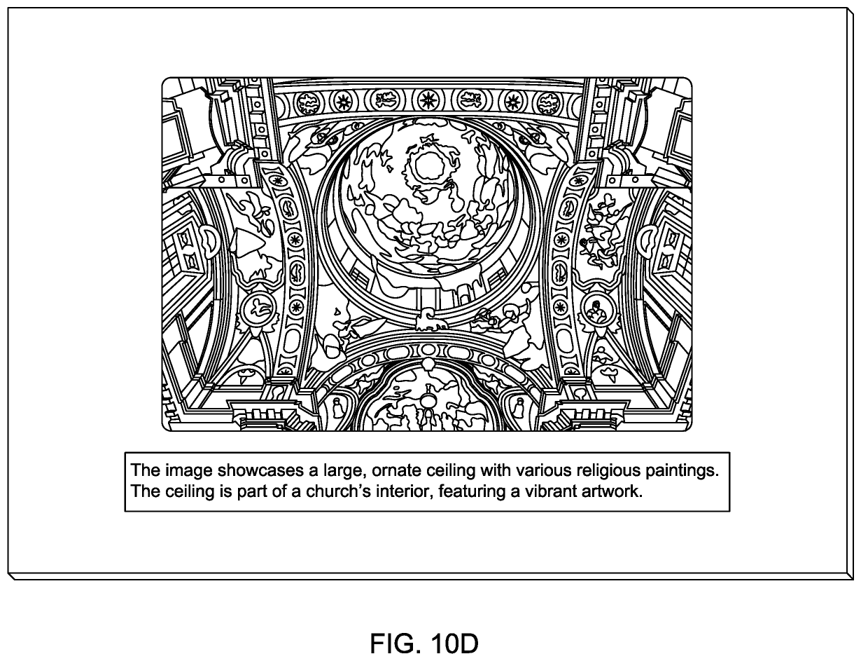

Image Level Captioning. FIG. 5C illustrates qualitative results for an image-level captioning task. For this task, GLaMM responds to queries like, “Could you please give me a detailed description of the image?” with a textual description. GLaMM's zero-shot performance is evaluated on Flickr30k and NoCap datasets, with Table. 6 showing its favorable performance against recent image captioning models and other LMMs (refer also to FIGS. 10A, 10B, 10C for qualitative results). Conventional image captioning is found in Harsh Agrawal, Karan Desai, Yufei Wang, Xinlei Chen, Rishabh Jain, Mark Johnson, Dhruv Batra, Devi Parikh, Stefan Lee, and Peter Anderson. nocaps: novel object captioning at scale. In ICCV, 2019, incorporated herein by reference in its entirety. The figures show the capabilities of GLaMM in generating detailed and context-aware captions for a diverse range of images. On FIG. 10A, GLaMM demonstrates its proficiency in text recognition within images; it accurately identifies and incorporates specific textual information, such as the brand name “TESCO,” into its caption. In FIG. 10B, GLaMM's capability to discern subtleties in visual content is showcased. It can effectively distinguish between live entities and inanimate objects, such as differentiating a living creature from a statue. On FIG. 10C, the figure demonstrates GLaMM's competence in reasoning about complex visual scenes. It can analyze and describe intricate details and interactions within an image, reflecting a deep understanding of both the individual elements and the overall context of the scene.

TABLE 5
Performance of GLaMM in Region-Level Captioning.

| | |
|---|---|
| refCOCOg | Visual Genome |

| Model | METEOR | CIDEr | METEOR | CIDEr |
|---|---|---|---|---|
| GRIT | 15.2 | 71.6 | 17.1 | 142 |
| Kosmos-2 | 14.1 | 62.3 | — | — |
| GPT4RoI | — | — | 17.4 | 145.2 |
| GLaMM (ZS) | 15.7 | 104.0 | 17.0 | 127.0 |
| GLaMM (FT) | 16.2 | 105.0 | 18.6 | 157.8 |

Metrics in Table 5 include METEOR and CIDEr scores, assessed on Visual Genome and refCOCOg Datasets, exhibiting competitive results. For region-level captioning, see Jialian Wu, Jianfeng Wang, Zhengyuan Yang, Zhe Gan, Zicheng Liu, Junsong Yuan, and Lijuan Wang. Grit: A generative region-to-text transformer for object understanding. arXiv:2212.00280, 2022; incorporated herein by reference in its entirety.

TABLE 6
Performance of GLaMM in Zero-Shot Image Captioning.

| | |
|---|---|
| NoCap | Flickr30k |

| Model | CIDEr | SPICE | CIDEr | SPICE |
|---|---|---|---|---|
| VinVLM | 95.5 | 13.5 | — | — |
| LEMON | 106.8 | 14.1 | — | — |
| SimVLM | 110.3 | 14.5 | — | — |
| CoCa | 120.6 | 15.5 | — | — |
| BLIP | 113.2 | 14.7 | — | — |
| BLIP-2 | 121.6 | 15.8 | — | — |
| InstructBLIP | 123.1 | — | 82.8 | — |
| Shikra-13B | — | — | 73.9 | — |
| Kosmos-1 | — | — | 67.1 | 14.5 |
| Kosmos-2 | — | — | 66.7 | — |
| GLaMM | 106.8 | 15.8 | 95.3 | 18.8 |

Performance of GLaMM in Zero-Shot Image Captioning: Assessed on Flickr30k and NoCap datasets in Table 6 show favorable results compared to recent models in the field, see Pengchuan Zhang, Xiujun Li, Xiaowei Hu, Jianwei Yang, Lei Zhang, Lijuan Wang, Yejin Choi, and Jianfeng Gao. Vinvl: Making visual representations matter in vision-language models. arXiv:2101.00529, 2021; Xiaowei Hu, Zhe Gan, Jianfeng Wang, Zhengyuan Yang, Zicheng Liu, Yumao Lu, and Lijuan Wang. Scaling up vision-language pre-training for image captioning. In CVPR, 2022; Zirui Wang, Jiahui Yu, Adams Wei Yu, Zihang Dai, Yulia Tsvetkov, and Yuan Cao. Simvlm: Simple visual language model pretraining with weak supervision. arXiv:2108.10904, 2021; Jiahui Yu, Zirui Wang, Vijay Vasudevan, Legg Yeung, Mojtaba Seyedhosseini, and Yonghui Wu. Coca: Contrastive captioners are image-text foundation models. arXiv:2205.01917, 2022; Junnan Li, Dongxu Li, Caiming Xiong, and Steven Hoi. Blip: Bootstrapping language-image pre-training for unified vision-language understanding and generation. In ICML, 2022; Junnan Li et al., 2023; Dai et al.; Chen et al.; Shaohan Huang, Li Dong, Wenhui Wang, Yaru Hao, Saksham Singhal, Shuming Ma, Tengchao Lv, Lei Cui, Owais Khan Mohammed, Qiang Liu, et al. Language is not all you need: Aligning perception with language models. arXiv:2302.14045, 2023; and Peng et al., each incorporated herein by reference in their entirety.

### Implementation Details

### 1. Evaluation Metrics

Mask Recall: To quantify region-specific grounding, a ‘mask recall’ metric utilizes a two-tiered validation approach. Initially, predicted masks are mapped to ground-truth masks via a one-to-one set assignment, followed by IoU computation for these pairs. Pairs surpassing a 0.5 IoU threshold proceed to a textual similarity assessment using BERT. A pair is considered a true positive (TP) only if both IoU and BERT similarity exceed their 0.5 thresholds; otherwise, it is classified as a false positive (FP). The mask recall is subsequently calculated using the standard formula, normalizing the number of TPs by the total ground-truth mask count.

### 2. Model Architecture and Training

[INVENTOR NOTE: What are the differences over the LISA model for the grounding image encoder and the pixel decoder?] In all experiments, Vicuna LLM is used with 7B parameters. The design of region encoder is motivated from GPT4RoI and grounding image encoder and pixel decoder are inspired from LISA. The Vicuna LLM is described in Lianmin Zheng, Wei-Lin Chiang, Ying Sheng, Siyuan Zhuang, Zhanghao Wu, Yonghao Zhuang, Zi Lin, Zhuohan Li, Dacheng Li, Eric. P Xing, Hao Zhang, Joseph E. Gonzalez, and Ion Stoica. Judging llm-as-a-judge with mt-bench and chatbot arena. arXiv:2306.05685, 2023, incorporated herein by reference in its entirety. The V-L and L-P layers are implemented using a linear layer. The PyTorch library is used to implement GLaMM and Deepspeed zero-2 optimization is used during training.

Specifically, the model is trained using two types of losses: auto-regressive cross-entropy loss for text generation and a linear combination of per-pixel binary cross-entropy loss and DICE loss for segmentation. During training, the global image encoder and grounding image encoder are kept frozen and the region encoder, projection layers (V-L and L-P) and the pixel decoder are fully finetuned, while the LLM is LORA finetuned with α=8.

### 2.1 Pretraining on GranD

During pretraining GLaMM is trained on GranD dataset for referring expression segmentation, region-level captioning, image-level captioning and grounded conversation generation (GCG) tasks simultaneously. A batch size of 160 is used and train for a total of 35K iterations during pretraining. LORA-8 is used for efficiently adapting the LLM and initialize the pretraining from GPT4RoI for faster convergence. In the experiment tables below, this model is referred to as GLaMM (ZS) which is obtained after pretraining on GranD.

### 3. Finetuning on Downstream Tasks

GLaMM is finetuned on multiple downstream tasks including GCG, referring expression segmentation, region-level captioning and image-level captioning. For GCG, the model is fine-tuneed on GranD_{f} dataset. A batch size of 160 is used and the model is trained for 5K iterations in total. It is worth noting that GranD_{f} dataset is a combination of multiple open-source datasets that is repurposed for GCG task using GPT4. Below are the prompts designed to query GPT4 for constructing GranDf dataset, along with the dataset visualizations.

For referring expressions segmentation, GLaMM is finetuned on refCOCO, refCOCO+ and refCOCOg datasets. This model is fine-tuned as GLaMM (FT) in Table 4. Similarly, for region-level captioning, GLaMM (FT) is fine-tuned on refCOCOg and Visual Genome datasets. For image-level captioning, GLaMM is fine-tuned on LLaVA-Instruct150K dataset. For LLaVA-bench, the model is fine-tuned on LLaVA-Instruct-80K instruction set. Further information on LLaVA is found in Haotian Liu, Visual instruction tuning. Eight NVIDIA A100-40GB GPUs are used in all of the pretraining and finetuning experiments.

### 4. Automated Dataset Annotation Pipeline

The automated annotation pipeline incorporates diverse state-of-the-art models at various levels. For Level-1, use Tag2Text and RAM for image tagging, CoDETR, EVAv02, OWL-ViT, and POMP for object localization, GRIT and GPT4RoI for attribute generation, and MiDAS for depth estimation. General information on image tagging is found in Xinyu Huang, Youcai Zhang, Jinyu Ma, Weiwei Tian, Rui Feng, Yuejie Zhang, Yaqian Li, Yandong Guo, and Lei Zhang. Tag2text: Guiding vision-language model via image tagging. arXiv:2303.05657, 2023; Youcai Zhang, Xinyu Huang, Jinyu Ma, Zhaoyang Li, Zhaochuan Luo, Yanchun Xie, Yuzhuo Qin, Tong Luo, Yaqian Li, Shilong Liu, et al. Recognize anything: A strong image tagging model. arXiv:2306.03514, 2023; Zhuofan Zong, Guanglu Song, and Yu Liu. Detrs with collaborative hybrid assignments training. In ICCV, 2023; Yuxin Fang, Quan Sun, Xinggang Wang, Tiejun Huang, Xinlong Wang, and Yue Cao. Eva-02: A visual representation for neon genesis. arXiv:2303.11331, 2023; Matthias Minderer, Alexey Gritsenko, Austin Stone, Maxim Neumann, Dirk Weissenborn, Alexey Dosovitskiy, Aravindh Mahendran, Anurag Arnab, Mostafa Dehghani, Zhuoran Shen, et al. Simple open-vocabulary object detection. In ECCV, 2022; Shuhuai Ren, Aston Zhang, Yi Zhu, Shuai Zhang, Shuai Zheng, Mu Li, Alex Smola, and Xu Sun. Prompt pretraining with twenty-thousand classes for open-vocabulary visual recognition. arXiv:2304.04704, 2023; Wu et al.; Shilong Zhang et al.; René Ranftl, Katrin Lasinger, David Hafner, Konrad Schindler, and Vladlen Koltun. Towards robust monocular depth estimation: Mixing datasets for zero-shot cross-dataset transfer. IEEE TPAMI, 2020, each incorporated herein by reference in its entirety. Level-2 leverages BLIP-2 and LLaVA-v1.5 for scene descriptions and landmark categorization, SpaCy for phrase extraction, and MDETR for phrase grounding. Instruction tuning is described in Haotian Liu, Chunyuan Li, Yuheng Li, and Yong Jae Lee. Improved baselines with visual instruction tuning. arXiv:2310.03744, 2023; Haotian Liu et al., Visual instruction tuning; Matthew Honnibal and Ines Montani. spaCy: Industrial-strength Natural Language Processing in Python. 2020; and Aishwarya Kamath, Mannat Singh, Yann LeCun, Gabriel Synnaeve, Ishan Misra, and Nicolas Carion. Mdetr-modulated detection for end-to-end multi-modal understanding. In ICCV, 2021, each incorporated herein by reference in their entirety. For both Level-3 and Level-4, use Vicuna-v1.5 with 13B parameters, supplemented with in-context examples.

A fully automated dataset annotation pipeline uses multiple hierarchical levels in the visual domain to construct GranD dataset. The segmentation masks for most of the regions are obtained from SAM annotations by comparing the detected labeled regions with SAM-provided class-agnostic regions. For the remaining regions that do not match with any of the

SAM regions, SAM model is run with a bounding box query to obtain masks.

The automated annotation pipeline utilizes only open-source models and incorporates a feedback loop using the chain of thoughts prompting via LLM. As it does not require feedback from the human in the loop, it can be scaled to generate dense noisy labels for a larger number of images, which can then be used to pretrain a larger LMM. Given the availability of enough compute power, this could be a step towards building a larger generic large multi-modal model. Below presents the LLM prompts used at different levels of the automated dataset annotation pipeline.

### 4.1. LLM Prompts and In-Context Learning

Landmark categorization: LLaVA-v1.5-13B model is used to assign landmark categories to each image. Table. 7 shows primary and fine categories.

TABLE 7
Summary of landmark categories and their
corresponding fine-grained categories.

| Main category | Fine Category |
|---|---|
| Indoor scene | Living space, Work space, Public space, |
| | Industrial space |
| Outdoor scene | Urban landscape, Rural landscape, Natural |
| | landscape |
| Transportation | Road, Airport, Train station, Port and harbor |
| scene | |
| Sports and | Sporting venue, Recreational area, Gym and |
| recreation scene | fitness center |

Dense Captioning: Objects, attributes and relationships are arranged hierarchically to construct a visual scene graph, that is used to query Vicuna-v1.5-13B model along with in-context examples to generate dense captions. The designed prompt is shown as follows.

Prompt: The provided prompt is a scene graph, which is a structured representation of a scene detailing its various elements and their relationships.

The scene graph consists of:
1. Layers of Depth: The scene is divided into different layers based on proximity—‘Immediate Foreground’, ‘Foreground’, ‘Midground’, and ‘Background’. Each layer depicts objects or entities at that depth in the scene.
2. Groups: Within each depth layer, objects and entities are clustered into groups, sometimes with specific attributes.
3. Relationships: This section illustrates the interactions or spatial relationships between various objects or groups.
4. Landmarks: It gives a broader view or categorization of the scene, defining its overarching theme or environment.

---

### ##EXAMPLE-1

Prompt: {scene_graph_1}
Desired caption: {dense_caption_1}

------

### ##EXAMPLE-2

Prompt: {scene_graph_2}
Desired caption: {dense_caption_2}

------

Please provide a simple and straightforward 2-4 sentence image caption based on the following scene graph details: {scene_graph}.

Create the caption as if you are directly observing the image. Do not mention the use of any source data like ‘The relationship indicates . . . ’ or ‘No relations specified’.

Extra Context: Vicuna-v1.5-13B model is queried to generate additional context about the visual scene. The prompt designed for this purpose is shown as follows.
Prompt:

### ##EXAMPLE-1

Prompt: {scene_graph_1}
Additional context: {caption_1}

------

### ##EXAMPLE-2

Prompt: {scene_graph_2}
Additional context: {caption_2}

------

Provide context based on the typical usage, history, potential dangers, and other interesting aspects surrounding the general theme presented by the objects and elements in the following scene graph: {scene_graph}

Limit the response to one paragraph with 5-7 sentences.

DO NOT mention, refer to, or hint about “objects”, “scene”, or “scene graph”.

ONLY focus on explaining use cases, history, potential dangers, etc.

### Additional Downstream Tasks

### 1. Phrase Grounding

Phrase grounding localizes a particular object in an image referred to by a natural language query. In order to adapt the GLaMM model for phrase grounding, the GCG dataset is repurposed to suit this particular task. Specifically, the answers in the GCG dataset are now used as questions, and the parts of the captions containing groundings are regarded as phrases. The model is subsequently trained to locate pixel-level groundings for these phrases, which are enclosed within <p> and </p> tokens. The results of this adaptation are shown in the following figure.

### 2. Conversational Style Question Answering

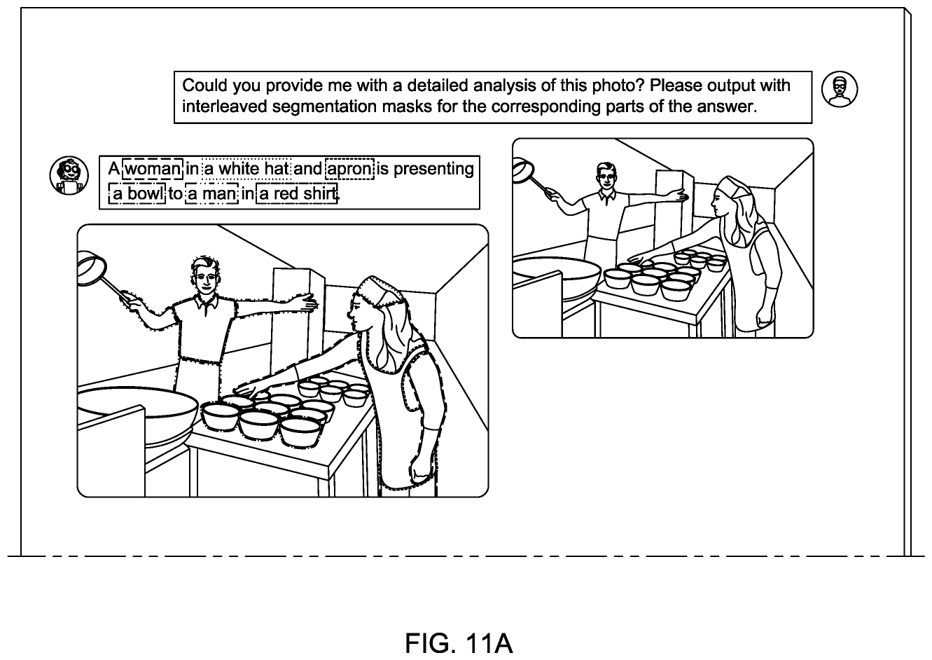

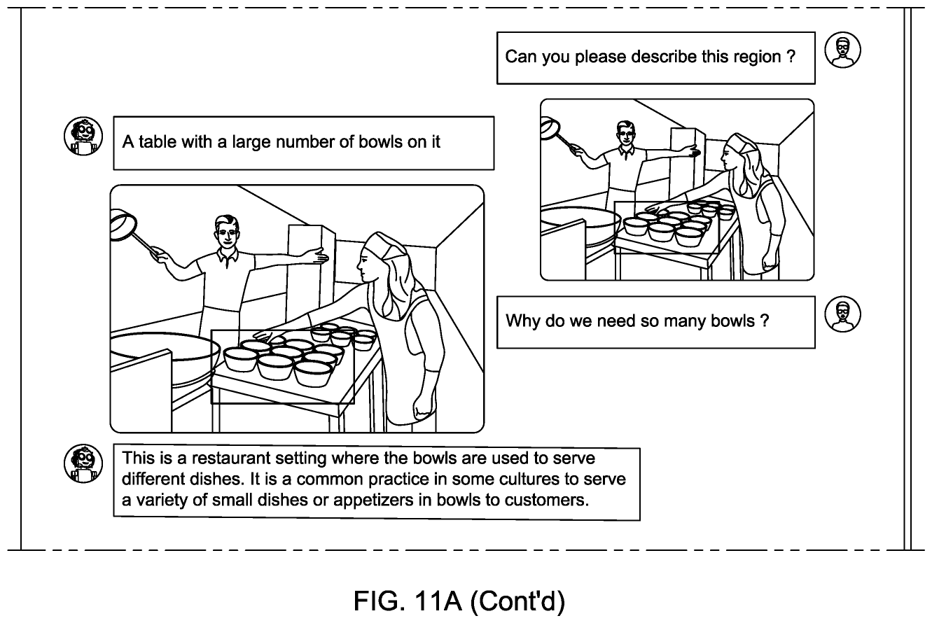

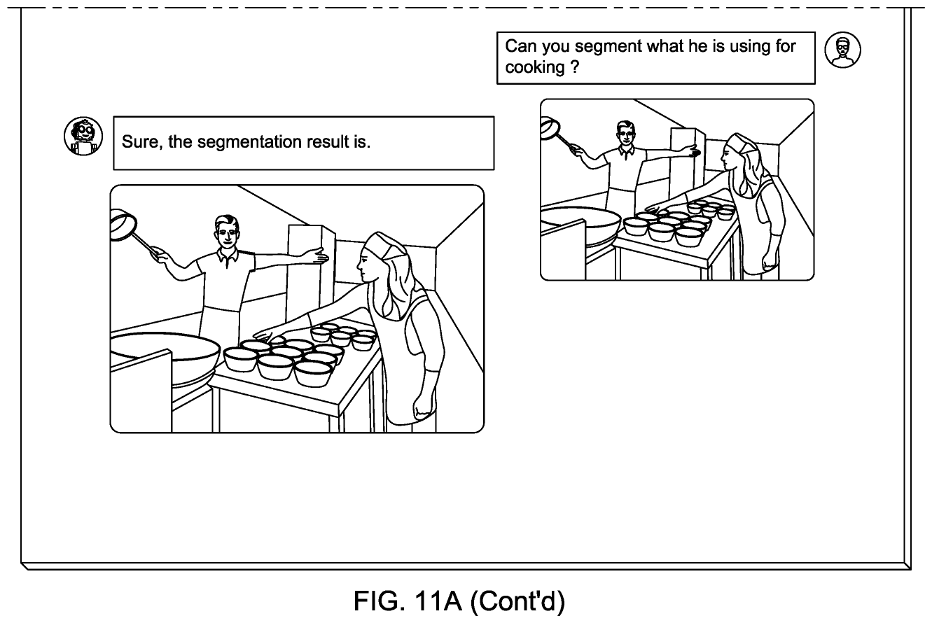

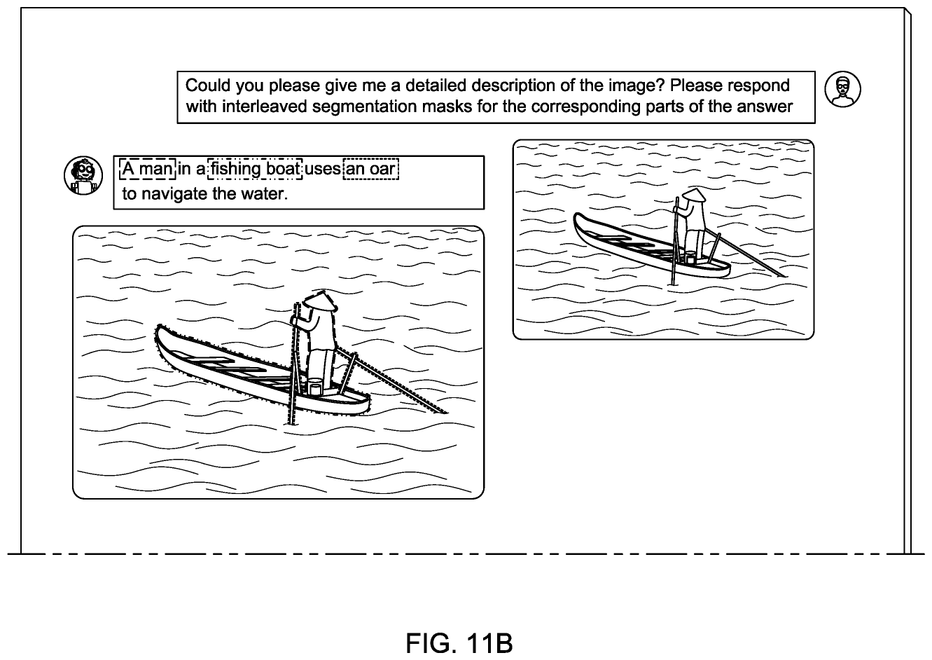

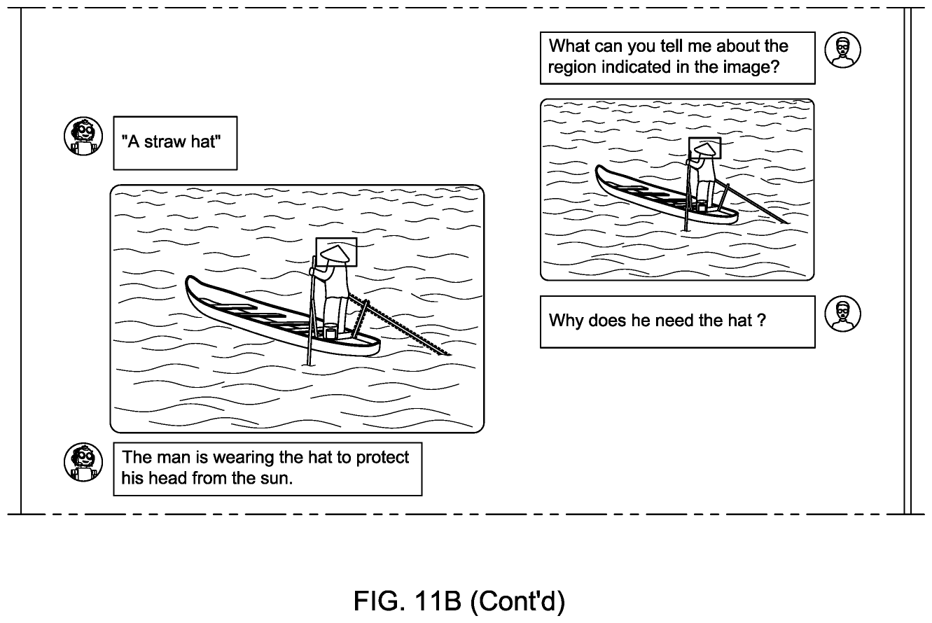

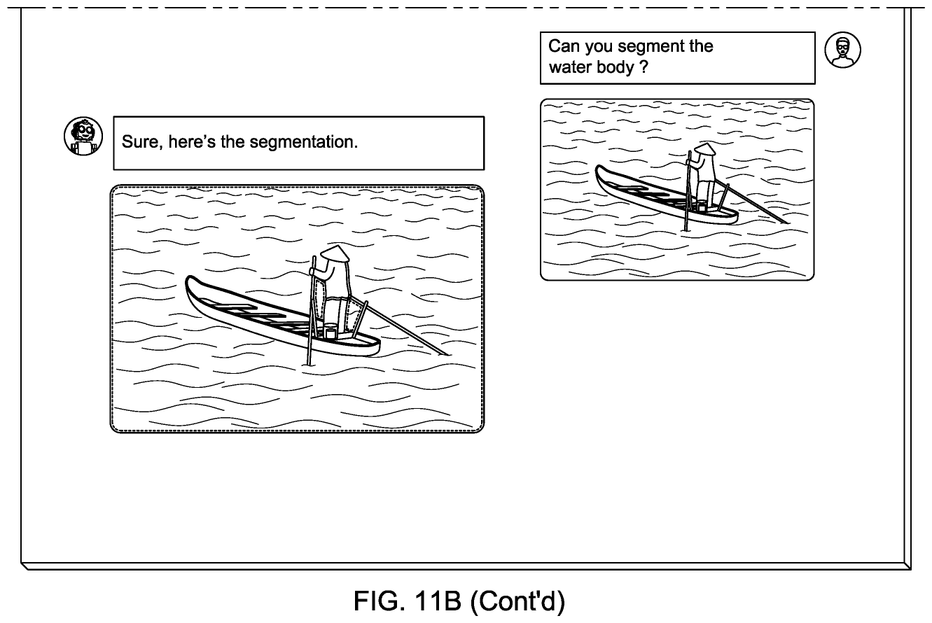

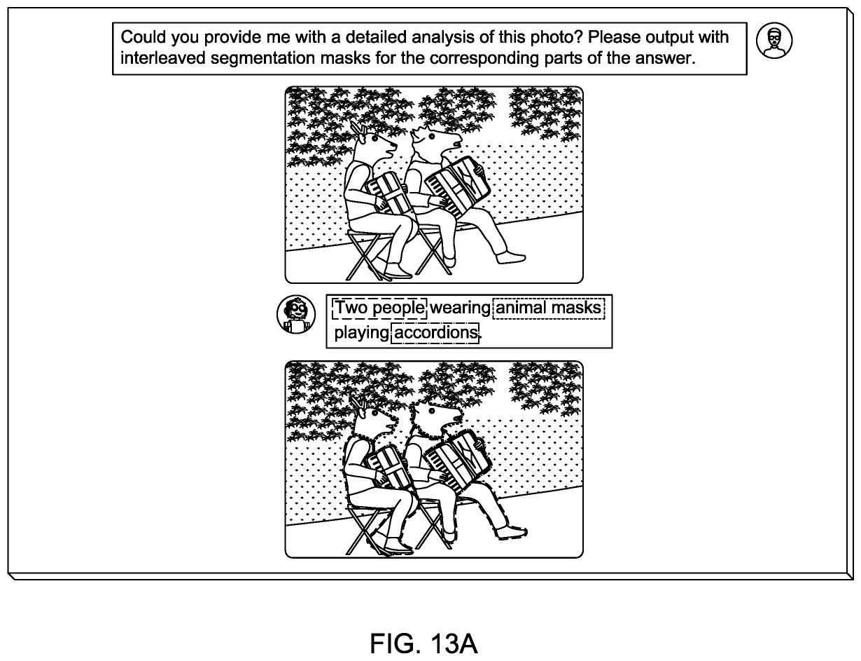

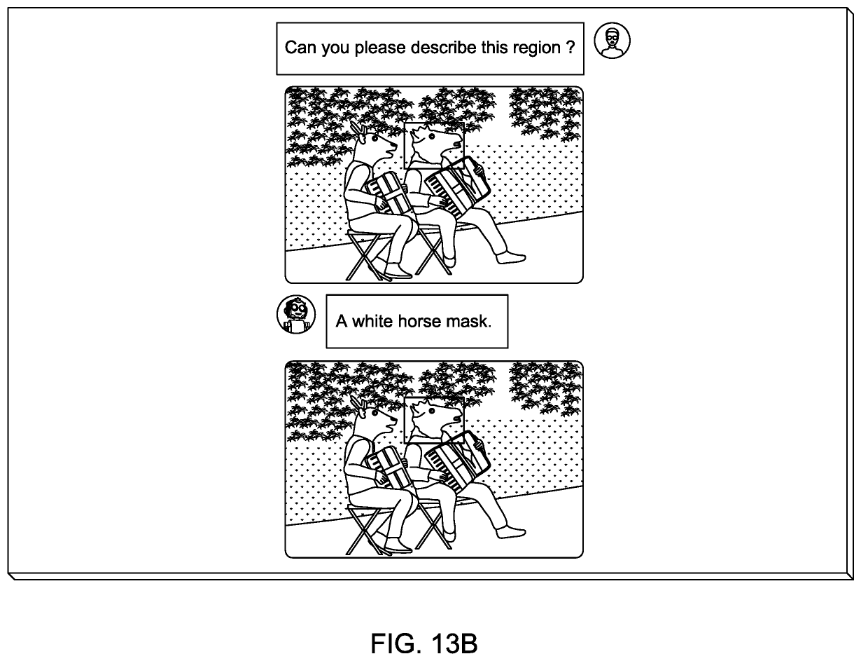

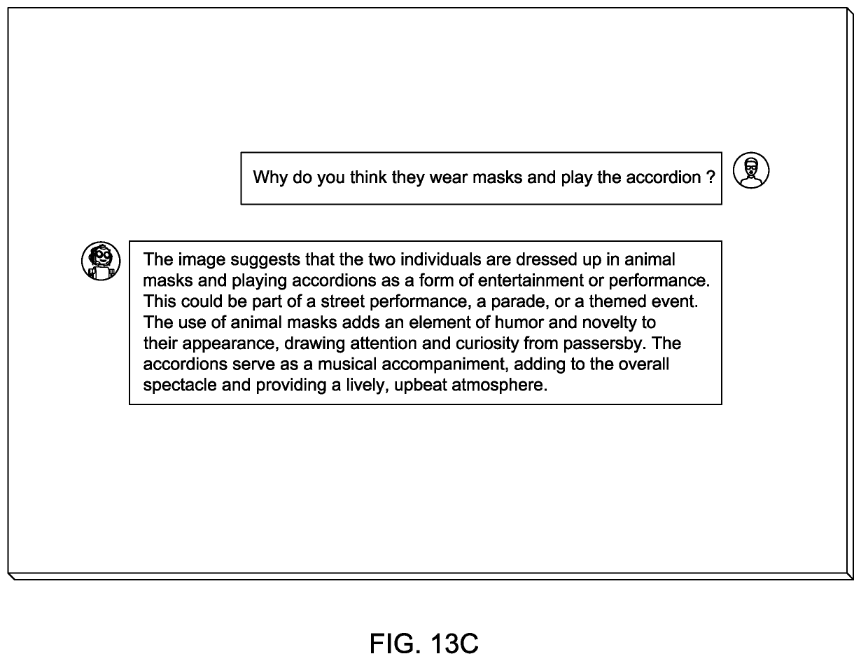

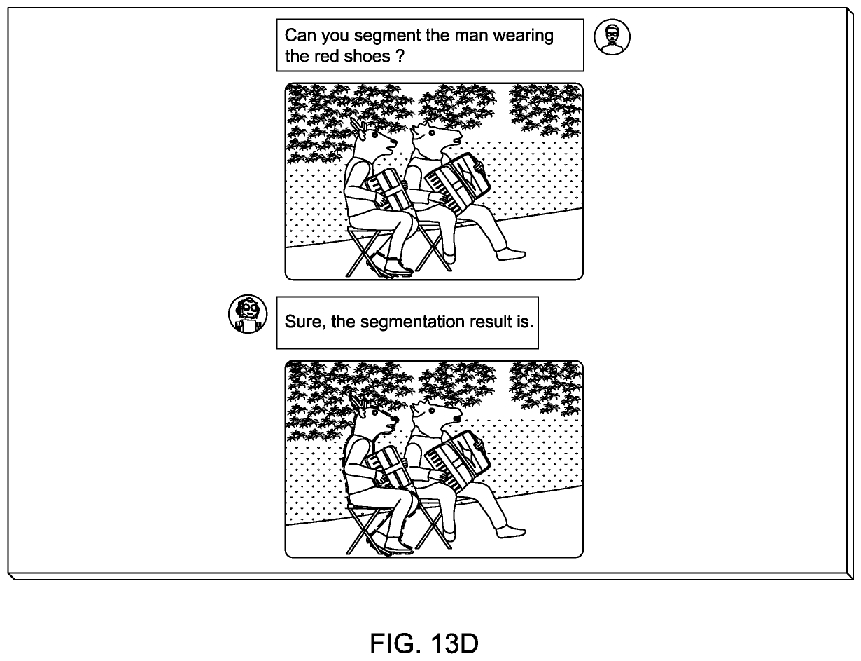

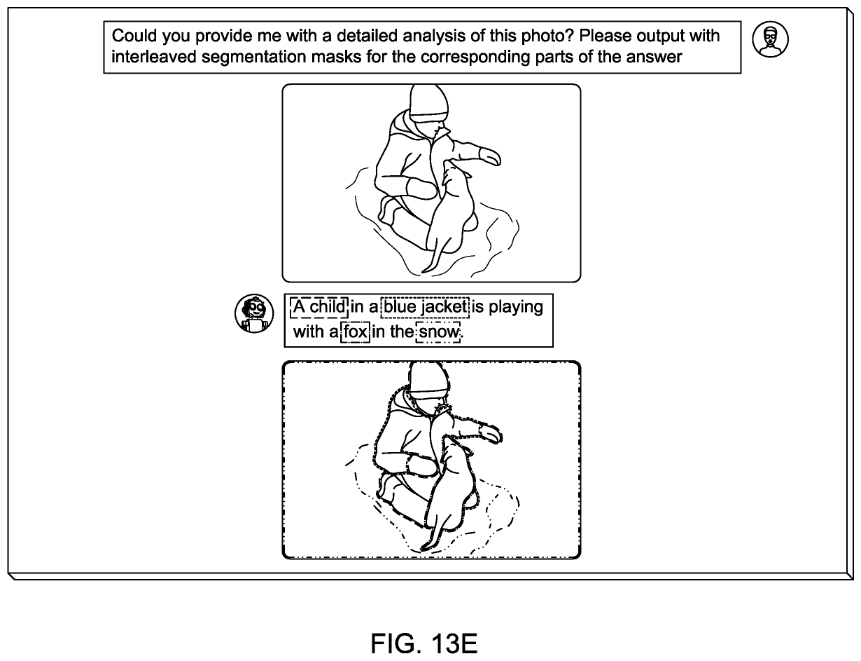

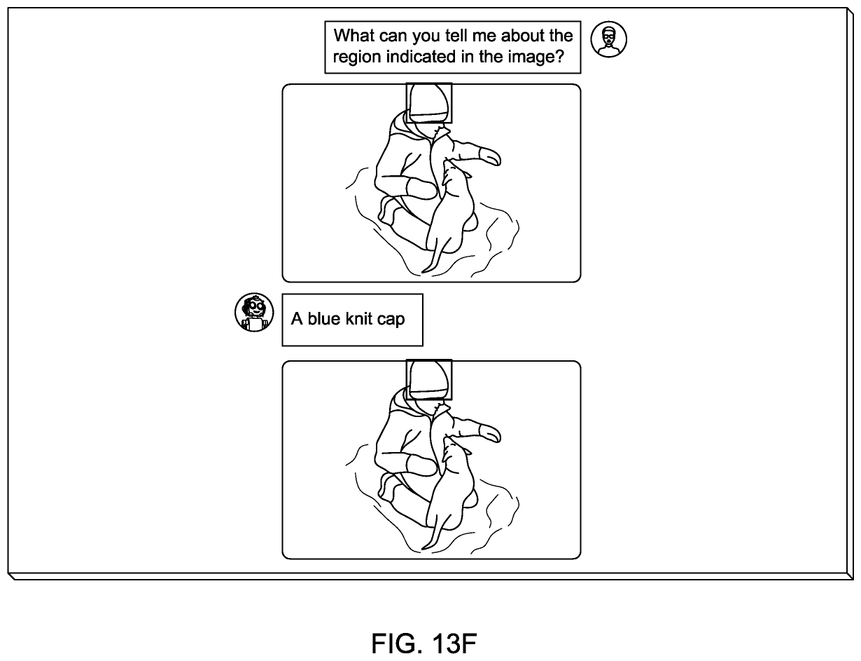

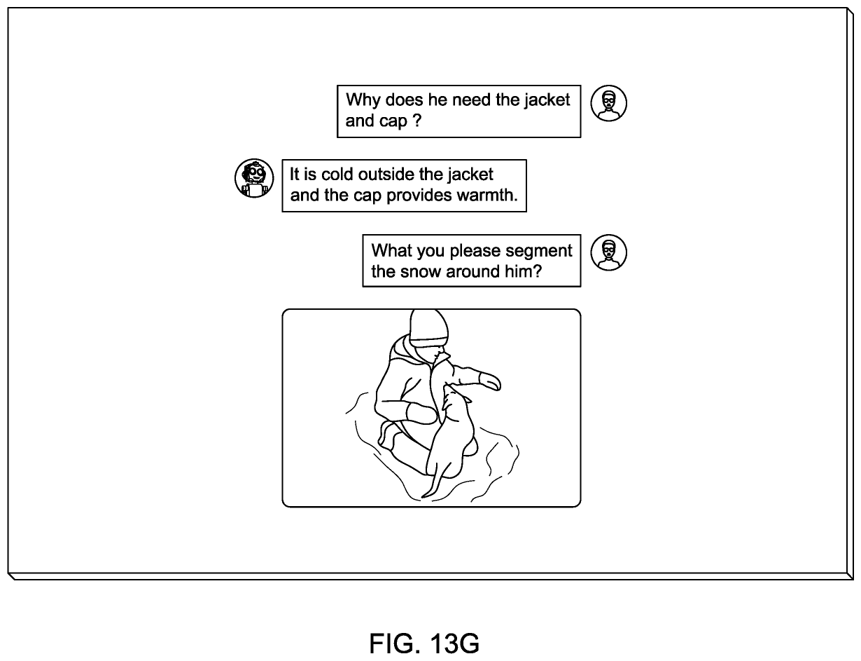

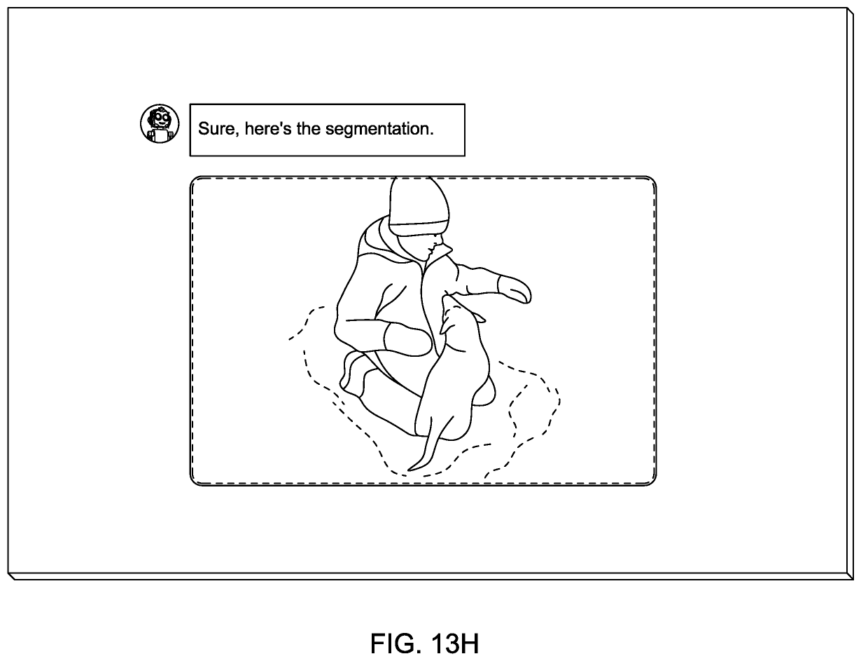

The model is evaluated on the LLaVA-Bench that uses GPT-4 for evaluation of models. Instruction tuning is described in Haotian Liu et al., Improved baselines with visual instructing tuning; and Haotian Liu et al., Visual instructing tuning, incorporated herein by reference in its entirety. This benchmark tests the model on three different types of tasks: conversation question-answering, detailed descriptions, and complex reasoning tasks. The evaluation provides insights into the model's conversational and reasoning capabilities. The results in Table 8 present a comparison of GLaMM with previous open-source models. Although, GLaMM uses LLaVA-1.1 as based model, its performance is on par with the recently released LLaVA-1.5 which leverages additional data and MLP for vision-to-language mapping. Qualitative results are shown in FIGS. 11A, 11B and FIGS. 13A-13H.

TABLE 8
Evaluation of GLaMM on conversational
style QA using LLaVA-Bench.

| Method | LLM | LLaVA^{W} |
|---|---|---|
| BLIP-2 | Vicuna-13B | 38.1 |
| InstructBLIP | Vicuna-7B | 60.9 |
| Qwen-VL | Qwen-7B | 63.4 |
| Qwen-VL-Chat | Qwen-7B | 58.6 |
| LLaVA-1.5 | Vicuna-7B | 63.4 |
| GLaMM | Vicuna-7B | 63.3 |

Table 8 compares GLaMM's performance with conventional open-source models in conversation question-answering, detailed descriptions, and complex reasoning tasks (see

Jinze Bai, Shuai Bai, Shusheng Yang, Shijie Wang, Sinan Tan, Peng Wang, Junyang Lin, Chang Zhou, and Jingren Zhou. Qwen-vl: A frontier large vision-language model with versatile abilities. arXiv:2308.12966, 2023; and Haotian Liu, Chunyuan Li, Yuheng Li, and Yong Jae Lee. Improved baselines with visual instruction tuning. arXiv:2310.03744, 2023, each incorporated herein by reference in their entirety).

FIGS. 11A and 11B show GLaMM engaging in multi-turn dialogues, providing detailed descriptions, addressing region-specific inquiries, and presenting grounded conversations. This effectively highlights its adaptability in intricate visual-language interactions and robustly retaining reasoning capabilities inherent to LLMs.

### Additional Qualitative Results

Next, more qualitative examples are provided to better understand the capacity of GLaMM.

### 1. Grounded Conversation Generation (GCG)

FIG. 7A, 7B, 7C shows qualitative results of GLaMM fine-tuned on GranD_{f} dataset. The model could produce dense captions and provide dense pixel-level groundings of the caption. The figures show how GLaMM seamlessly generates detailed responses, grounding phrases using pixel-level masks showing its detailed understanding.

### 2. Referring Expression Segmentation

FIGS. 8A, 8B, 8C shows the effectiveness of GLaMM in understanding the natural language query and segmenting the corresponding objects. Note that GLaMM can also segment multiple objects via multi-round conversations. The figures illustrate how GLaMM effectively translates text-based referring expressions into corresponding segmentation masks. Leveraging its training on the GranD dataset, the model can provide pixel-grounded reasoning and operate across various levels of granularity.

### 3. Region-Level Captioning

FIGS. 9A, 9B, 9C shows the qualitative results of GLaMM for region-level understanding. The model can generate detailed descriptions about the user-specified regions in an image. The figures demonstrate GLaMM's ability to generate region-specific captions adeptly, translating the intricate details from designated regions into coherent textual descriptions, enriched by its training on the comprehensive GranD dataset. This capability, combined with the inherent reasoning abilities of LLMs, enables it to tackle reasoning-based visual questions about these regions.

### 4. Image-Level Captioning

FIGS. 10A, 10B shows GLaMM's qualitative results on captioning tasks. The model can generate dense captions for images. The figures show the capabilities of GLaMM in generating detailed and context-aware captions for a diverse range of images. In FIG. 10A, GLaMM demonstrates its proficiency in text recognition within images; it accurately identifies and incorporates specific textual information, such as the brand name “TESCO,” into its caption.

In FIG. 10B, GLaMM's capability to discern subtleties in visual content is showcased. It can effectively distinguish between live entities and inanimate objects, such as differentiating a living creature from a statue.

On FIG. 10C, the figure demonstrates GLaMM's competence in reasoning about complex visual scenes. It can analyze and describe intricate details and interactions within an image, reflecting a deep understanding of both the individual elements and the overall context of the scene.

FIGS. 10C, 10D illustrate an example user interaction for an image-level captioning task. On an input side in FIG. 10C, a field is provided for inputting a text instruction and a field is provided for providing an image. Upon completing the input, a Submit button may be used to send the input in order to obtain a response. In FIG. 10D, the user interface can display an output image and a text response.

### 5. Conditional Image Generation

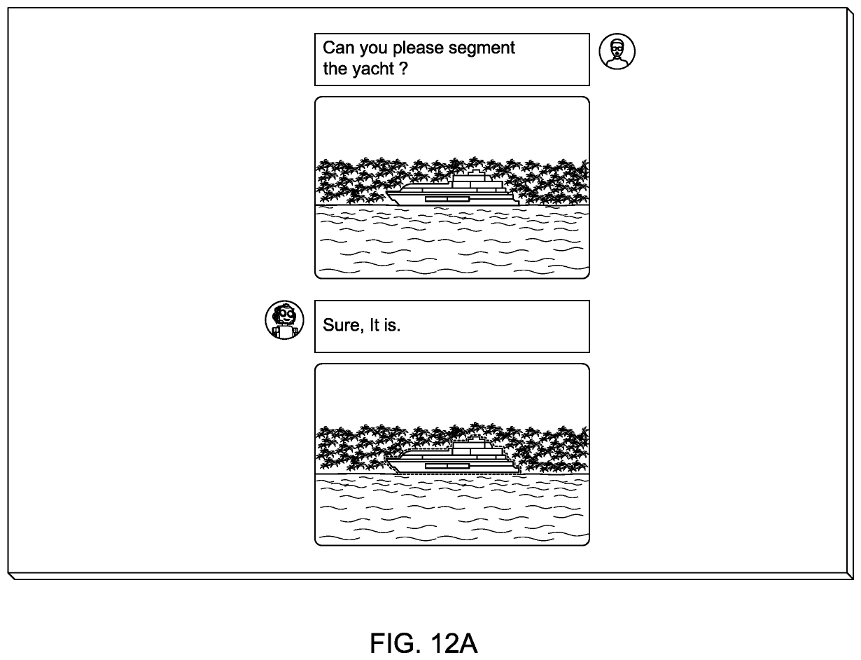

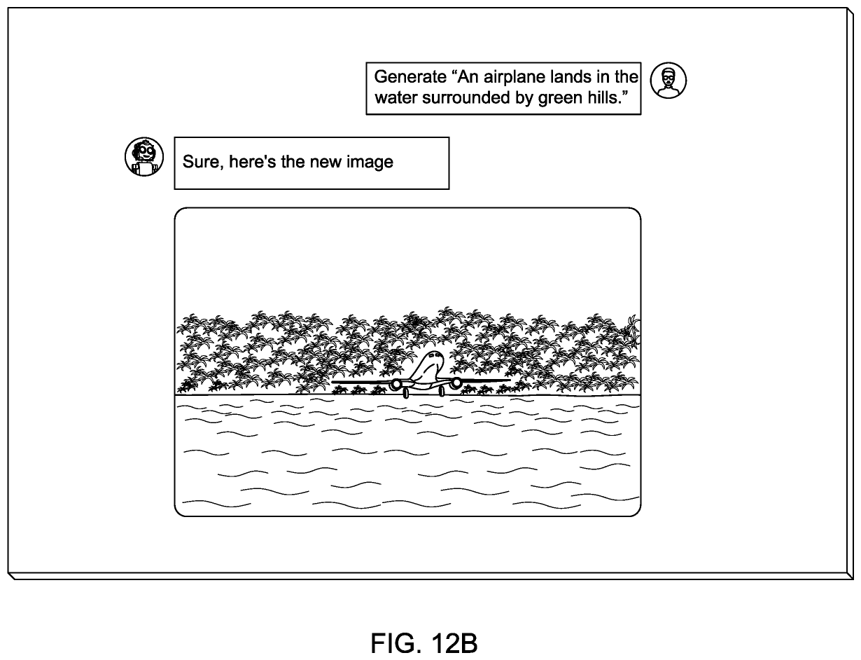

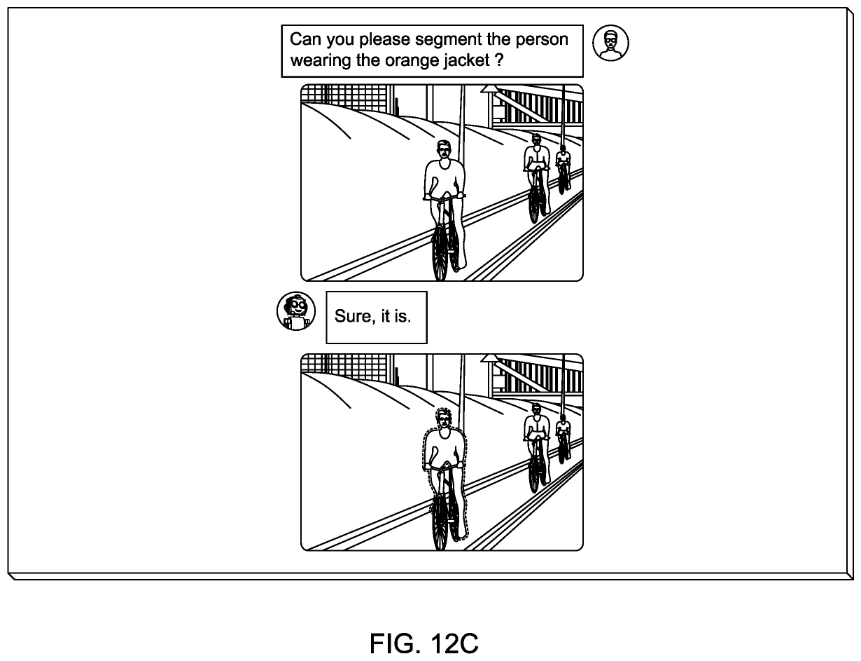

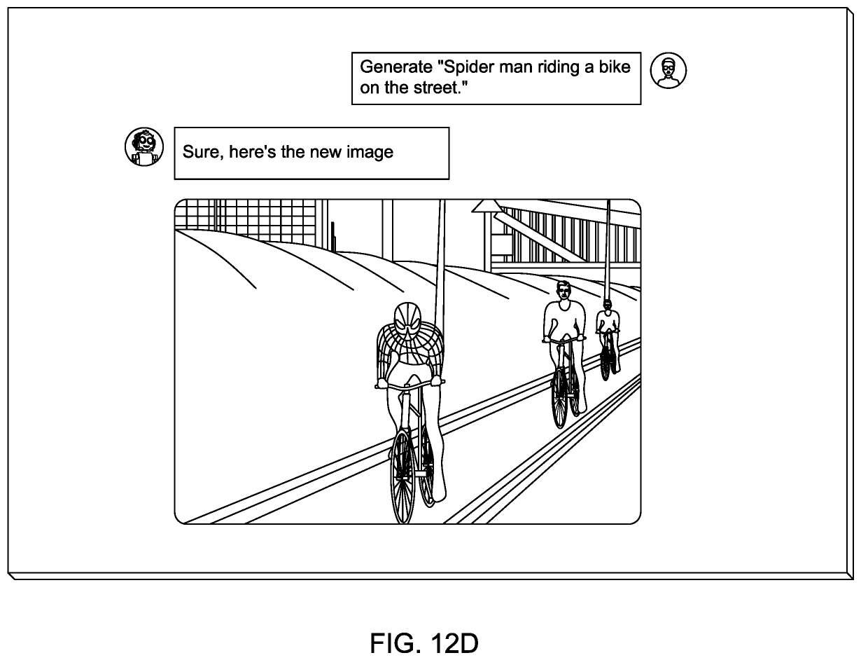

FIGS. 12A-12D show GLaMM's seamless integration for generative tasks. The Stable Diffusion uses inpainting model stable-diffusion-xl-1.0-inpainting for this task. Latent diffusion models are discussed in Robin Rombach, Andreas Blattmann, Dominik Lorenz, Patrick Esser, and Björn Ommer. High-resolution image synthesis with latent diffusion models. arXiv:2112.10752, 2021, incorporated herein by reference in its entirety. First generate a segmentation mask using the GlaMM model based on the user query. This segmentation mask along with the user prompt is given as the input to the Stable Diffusion inpainting model, which generates the final output.

FIGS. 12A-12D show the integration of GLaMM with an image generation model (stable diffusion). GlaMM first generates the segmentation mask (e.g., “yacht” in the left image and “person wearing orange jacket” in the right image) which is used along with a text prompt as input to the diffusion model to generate the desired images.

### 6. Conversations

FIGS. 13A-13H illustrate the functionality of GLaMM to engage in multi-purpose task conversations. GLaMM is a generic conversational model that can accept prompts in the form of text and/or region and can answer in the form of text and/or segmentation masks. Note that the model is not explicitly trained to handle such scenarios, and this behavior emerges mainly due to pretraining on GranD dataset, where an image is presented to LMM in different contexts.

FIGS. 13A-13H show multimodal conversations generated through GLaMM. The model is flexible enough to process multimodal inputs and respond with multimodal outputs in a single conversation.

### Dataset Visualization

In this section, additional dataset samples of the GranD and GranDf datasets are provided to better understand the functionalities they offer. FIGS. 14A-14I illustrate dataset samples from GranD_{f}. The figures show the GPT4 prompts used and the created dataset samples from GranD_{f} dataset. This repurposed human-annotated dataset provides rich semantics to GLaMM for GCG task.

Referring to FIGS. 14A-14I a prompt includes five base captions for an image briefly describing the image from different perspective. A prompt further includes a number of relationships between objects in the image. Each relationship consists of [subject, relation/verb, object]. Note that each subject and object follows the format <entitiy name>-<object number in image>. For example, if there are five persons and two tables, they will be formatted as person-1, person-2, . . . , person-5 and table-1, table-2.

The dataset includes a concise image caption that straightforwardly describes objects/things visible in the image, using provided relationships. The dataset uses the base captions for context understanding, but it is not mandatory to include them verbatim in the final description. Break down the description into shorter sentences. Importantly the names of the subject and object are kept unchanged. The description is broken down into shorter, clear sentences.

FIGS. 15A and 15B illustrate dataset samples from GranD. The figures show a few samples from the GranD dataset, generated using the automated annotation pipeline. It provides multiple semantic labels and attributes for detected objects, along with the grounded dense caption and additional context.

FIG. 15A can further include a dense caption of: A group of children are practicing a first aid course in a classroom. A mannequin wearing a blue shirt, surrounded by young boys, including two wearing blue shirts. There are various items on the table, such as a laptop, projector, and markers. A chair and a blackboard with a red and white lifesaver jacket is also seen in the room. The boys are bending over the mannequin, possibly practicing CPR, while a women watches.

Additional context can include that the image depicts a first aid training session, likely aimed at teaching children basic life-saving techniques like CPR. Given the classroom setting and the presence of a projector and laptop, it may be part of a structured educational program. First aid courses like this are crucial for empowering people to handle emergencies effectively, reducing the severity of injuries or even saving lives. However, improper technique can be potentially dangerous, emphasizing the importance of qualified supervision, in this case, provided by the watching woman. The lifesaver jacket on the blackboard hints at a broader scope of training, possibly including water safety. The brown table with a laptop on it serves as a functional workspace, allowing for remote work or study in a cozy environment.

FIG. 15B can further include a dense caption of: Two women with backpacks are taking a selfie with cellphone in front of a flower-covered wall, enjoying their time together in the city. One of them is wearing a gray jacket and a white and gray backpack, while the other is holding a umbrella and a black backpack with a white tag. They are surrounded by potted plants and a tall planter of flowers.

Additional context can include that in the urban landscape, individuals often carry various bags and backpacks to store their belongings, such as handbags, shopping bags, and backpacks. These bags are usually made of durable materials like canvas or nylon and come in different colors, sizes, and styles. Some people prefer to carry a scarf or a jacket to protect themselves from the elements, while others wear jeans or trousers for comfort and convenience. Outdoor spaces in the city may feature potted plants, flower arrangements, and other decorative elements to enhance the aesthetic appeal of the area. Cell phones and other electronic devices have become essential for communication and accessing information on-the-go. In outdoor settings, people often use these devices to capture memories, stay connected with others, and navigate their surroundings.

The large-scale automated pipeline provides dense labels that are important for pretraining but still contains some noise. A high-quality, clean dataset mayfurther improve the pretrained representations, although at a significantly higher annotation cost. The present disclosure includes a cost-effective annotation pipeline aimed at reducing noise in dense labelingand an expanded GLaMM framework that include modalities such as video and 3D.

### Ethics and Societal Impact

The Grounding-anything Dataset (GranD) utilizes SAM images that have de-identified personal information, with all faces and license plates obscured. The dataset does not portray any strong biases or discrimination. The responsible use of GranD and GLaMM is urged, promoting research progress while safeguarding privacy.

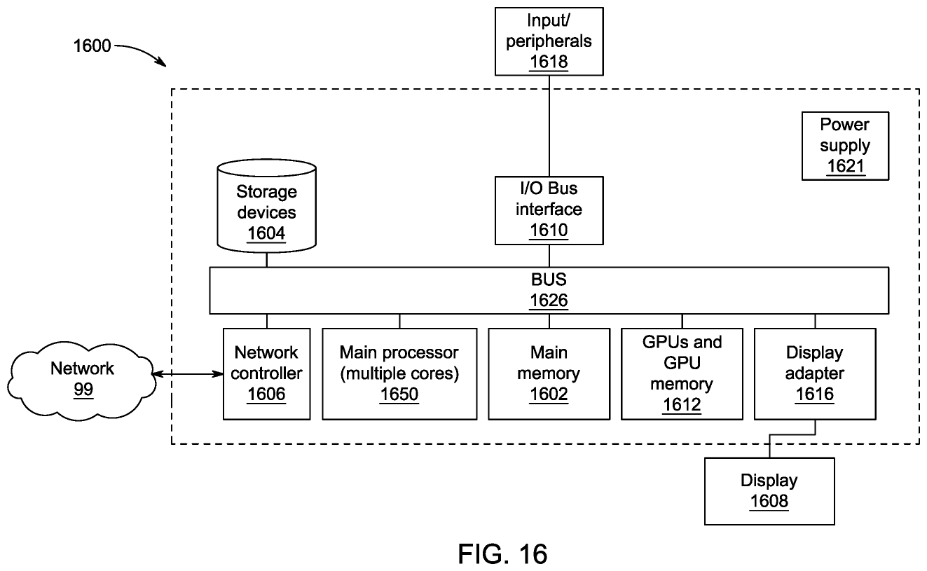

FIG. 16 is a block diagram illustrating an example computer system for implementing the machine learning training and inference methods according to an exemplary aspect of the disclosure. The computer system may be an AI workstation running an operating system, for example Ubuntu Linux OS, Windows, a version of Unix OS, or Mac OS. The computer system 1600 may include one or more central processing units (CPU) 1650 having multiple cores. The computer system 1600 may include a graphics board 1612 having multiple GPUs, each GPU having GPU memory. The graphics board 1612 may perform many of the mathematical operations of the disclosed machine learning methods. The computer system 1600 includes main memory 1602, typically random access memory RAM, which contains the software being executed by the processing cores 1650 and GPUs 1612, as well as a non-volatile storage device 1604 for storing data and the software programs. In preferred embodiments, the above-described machine learning models are software programs stored in a repository, for example GitHub, available for download. In preferred embodiments, the software programs are implemented using PyTorch or Tensorflow, configured for execution using GPUs.

Several interfaces for interacting with the computer system 1600 may be provided, including an I/O Bus Interface 1610, Input/Peripherals 1618 such as a keyboard, touch pad, mouse, Display Adapter 1616 and one or more Displays 1608 for displaying the above exemplary user interfaces, and a Network Controller 1606 to enable wired or wireless communication through a network 99. The interfaces, memory and processors may communicate over the system bus 1626. The computer system 1600 includes a power supply 1621, which may be a redundant power supply.

In some embodiments, the computer system 1600 may include a server CPU and a graphics card by NVIDIA, in which the GPUs have multiple CUDA cores. In some embodiments, the computer system 1600 may include a machine learning engine 1612.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A system for grounded multimodal conversation, comprising:
an input for receiving an image;
a global image encoder connected to a vision-to-language (V-L) projection layer for encoding the image and projecting the encoded image into scene text;
a region encoder configured to construct a hierarchical feature pyramid from selected layers of the global image encoder, followed by a Region of Interest align layer to generate a region of interest feature map,
wherein the V-L projection layer is configured to map features of the region of interest feature map into projected image features in language domain;
a large language model configured to receive an input of an augmentation of text instruction and region features and generate a grounded conversation concerning the image;
a language-to-prompt projection layer configured to transform last-layer embeddings of the large language model corresponding to segment tokens into a pixel decoder feature space; and
a grounding image encoder,
wherein the pixel decoder utilizes the pixel decoder feature space together with the grounding image encoder to produce fine-grained pixel-level object grounding.

2. The system of claim 1, wherein the region encoder is configured to receive user-specified regions as inputs and project the regions to the language domain through the V-L projection layer; and
wherein the large language model is configured to take as input a text instruction that incorporates bounding box tokens for corresponding region features to obtain an augmented text instruction and generate an output text for understanding of the region.

3. The system of claim 1, wherein, for pixel-level object grounding, the large language model is configured to generate responses which correspond to segment tokens, and
wherein the pixel decoder is configured to produce a binary segmentation mask.

4. The system of claim 3, wherein the large language model is configured to take as input a prompt related to regions in the input image and generate a caption along with interleaved binary segmentation masks.

5. The system of claim 1, further comprising an automated annotation pipeline to create a dataset for training the system, the pipeline comprises:
a first module for identifying objects within a plurality of training images;
a second module for defining relationships between the objects;
a third module for producing a hierarchical scene graph from the identified objects and identifying relationships between the objects; and
a fourth module for creating a detailed visual understanding by querying the large language model to extract contextual information.

6. The system of claim 4, wherein the large language model is configured to generate the caption along with the interleaved binary segmentation masks using tokens to delineate a start and end of each phrase in the caption and its corresponding region mask.

7. The system of claim 1, wherein the input text instruction is a request to segment objects in the image, and
wherein the large language model is configured to output a text-based referring expression and the pixel decoder is configured to produce a segmentation mask for the image in conjunction with a text response.

8. The system of claim 1, wherein the input text instruction is a request to describe the image, and
wherein the large language model is configured to output a text description of the image.

9. The system of claim 1, wherein the input text instruction is a request to segment an expression that relates to a description of the image into a plurality of phrases that correspond to regions determined by the region encoder.

10. The system of claim 1, wherein the large language model is configured to conduct a multi-turn dialogue, including receiving one or more inquiries, generating descriptions of the image and the regions, and generating a grounded conversation concerning the image.

11. A non-transitory computer-readable storage medium including computer executable instructions, wherein the instructions, when executed by a computer, cause the computer to perform a method for grounded multimodal conversation, the method comprising:
receiving an image;
encoding, by a global image encoder connected to a vision-to-language (V-L) projection layer, the image and projecting the encoded image into scene text;
constructing, by a region encoder, a hierarchical feature pyramid from selected layers of the global image encoder, followed by generating, by a Region of Interest align layer, a region of interest feature map;
mapping, by the V-L projection layer, features of the region of interest feature map into projected image features in language domain;
receiving, by a large language model, an input of an augmentation of text instruction and region features and generating a grounded conversation concerning the image;
transforming, by a language-to-prompt projection layer, last-layer embeddings of the large language model corresponding to segment tokens into a pixel decoder feature space;
and
producing, by the pixel decoder utilizing the pixel decoder feature space together with the grounding image encoder, fine-grained pixel-level object grounding.

12. The computer readable storage medium of claim 11, further comprising:
receiving, by the region encoder, user-specified regions as inputs and projecting the regions to the language domain through the V-L projection layer; and
inputting, to the large language model, a text instruction that incorporates bounding box tokens for corresponding region features to obtain an augmented text instruction and generating an output text for understanding of the region.

13. The computer readable storage medium of claim 11, further comprising:
generating for pixel-level object grounding, by the large language model, responses which correspond to segment tokens; and
producing, by the pixel decoder, a binary segmentation mask.

14. The computer readable storage medium of claim 13, further comprising:
inputting to the large language model a prompt related to regions in the received image; and
generating a caption along with interleaved binary segmentation masks.

15. The computer readable storage medium of claim 11, further comprising creating, by an automated annotation pipeline, a training dataset, the pipeline comprises:
identifying objects within a plurality of training images;
defining relationships between the objects;
producing a hierarchical scene graph from the identified objects and identifying relationships between the objects; and
creating a detailed visual understanding by querying the large language model to extract contextual information.

16. The computer readable storage medium of claim 14, further comprising generating, by the large language model, the caption along with the interleaved binary segmentation masks using tokens to delineate a start and end of each phrase in the caption and its corresponding region mask.

17. The computer readable storage medium of claim 11, wherein the input text instruction is a request to segment objects in the image, the method further comprising:
outputting a text-based referring expression; and
producing, by the pixel decoder, a segmentation mask for the image in conjunction with a text response.

18. The computer readable storage medium of claim 11, wherein the input text instruction is a request to describe the image, the method further comprising
outputting, by the large language model, a text description of the image.

19. The computer readable storage medium of claim 11, wherein the input text instruction is a request to segment an expression that relates to a description of the image, the method further comprising
segmenting the image description into a plurality of phrases that correspond to regions determined by the region encoder.

20. The computer readable storage medium of claim 11, further comprising conducting, by the large language model, a multi-turn dialogue, including
receiving one or more inquiries,
generating descriptions of the image and the regions, and
generating a grounded conversation concerning the image.
